(19) United States
(12) Patent Application Publication
(10) Pub. No.: US 2023/0262103 A1
(43) Pub. Date: Aug. 17, 2023

(54) SYSTEMS AND METHODS FOR ASSOCIATING DUAL-PATH RESOURCE LOCATORS WITH STREAMING CONTENT

(71) Applicant: CGIP HOLDCO, LLC, Stamford, CT (US)

(72) Inventors: Jeffrey Specter, Stamford, CT (US); Vineet Choudhary, Austin, TX (US)

(73) Assignee: CGIP HOLDCO, LLC, Stamford, CT (US)

(21) Appl. No.: 18/138,941

(22) Filed: Apr. 25, 2023

Related U.S. Application Data
(63) Continuation-in-part of application No. 16/574,640, filed on Sep. 18, 2019, now Pat. No. 11,663,218.
(60) Provisional application No. 63/444,735, filed on Feb. 10, 2023.

(51) Int. Cl. H04L 65/61; G06N 20/00; H04L 45/00

(52) U.S. Cl. CPC H04L 65/61; G06N 20/00; H04L 45/22

(57) ABSTRACT

Disclosed herein are systems and methods associated with content creation and promotion. In some embodiments, a system for resource locator element generation may include receiving user input, generating a resource datum as a function of the user input, generating resource language as a function of the resource datum using a resource language machine learning model, generating resource locator element as a function of the resource language, and transmitting the resource locator element to a user device.

### CROSS-REFERENCE TO RELATED APPLICATIONS

This application is a continuation-in-part of Non-provisional application No. 16/574,640 filed on Sep. 18, 2019, and entitled “SYSTEMS AND METHODS FOR ASSOCIATING DUAL-PATH RESOURCE LOCATORS WITH STREAMING CONTENT,” the entirety of which is incorporated herein by reference. This application claims the benefit of priority of U.S. Provisional Patent Application Ser. No. 63/444,735, filed on Feb. 10, 2023, and titled “SYSTEMS AND METHODS FOR CONNECTOR APPLICATION FUNCTIONALITY,” the entirety of which is incorporated herein by reference.

### FIELD OF THE INVENTION

The present invention generally relates to the field of content creation. In particular, the present invention is directed at systems and methods for associating dual-path resource locators with streaming content.

### BACKGROUND

Association of resource locators with audio content by traditional manual and/or timing-based processes is labor intensive and can represent a prohibitive barrier to the establishment of such associations, particularly where streamed content is voluminous and may be transient. A result can be the balkanization of data according to content type, inhibiting connectedness in networked computing, with a concomitant loss of user access to resources that otherwise might be identified.

### SUMMARY OF THE DISCLOSURE

In an aspect, a system for associating dual-path resource locators with streaming content includes at least a processor and a memory communicatively connected to the at least processor, the memory containing instructions configuring the at least processor to receive user input, generate a resource datum as a function of the user input, generate resource language as a function of the resource datum using a resource language machine learning model, generate resource locator element as a function of the resource language, and transmit the resource locator element to a promoted entity device, a content creator device, or both.

In another aspect, a method for associating dual-path resource locators with streaming content includes using at least a processor, receiving user input, using at least a processor, generating a resource datum as a function of the user input; using at least a processor, generating resource language as a function of the resource datum using a resource language machine learning model, using at least a processor, generating resource locator element as a function of the resource language, and using at least a processor, transmitting the resource locator element to a promoted entity device, a content creator device, or both.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating a method of associating dual-path resource locators with streaming content;

FIG. 2 is a block diagram of an exemplary streaming network according to an embodiment of the present invention;

FIG. 3 is a block diagram illustrating an exemplary embodiment of a central database;

FIG. 4 is a block diagram of a language processing engine according to an embodiment of the present invention;

FIG. 5 is a block diagram illustrating a dual-path resource locator table according to an embodiment of the present invention;

FIG. 6 is an exemplary embodiment of a historical data bin;

FIG. 7 is exemplary flow diagram of a method for identifier exchange through a historical data bin;

FIG. 8 is a block diagram illustrating an exemplary system for connector application functionality;

FIG. 9 is a flow diagram illustrating an exemplary method of connector application functionality;

FIG. 10 is a diagram illustrating an exemplary system for resource locator element generation;

FIG. 11 is a flow diagram illustrating an exemplary method of script generation;

FIG. 12 is a diagram illustrating an exemplary machine learning module;

FIG. 13 is a diagram illustrating an exemplary neural network;

FIG. 14 is a diagram illustrating an exemplary neural network node;

FIG. 15 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to methods that apply machine-learning processing algorithms to heterogenous linguistic datasets to display content from a promoted entity device based on selection by a content creator. Content may include a textual element with an associated uniform resource locator (URL) related to the promoted entity device that is displayed on an audience device during a continuous data stream. Audience members who are listening to and/or viewing the streaming content will see the textual display of the promoted entity upon the content creator speaking a triggering word, wherein audience members may interact with the display and be redirected to a promoted entity's URL.

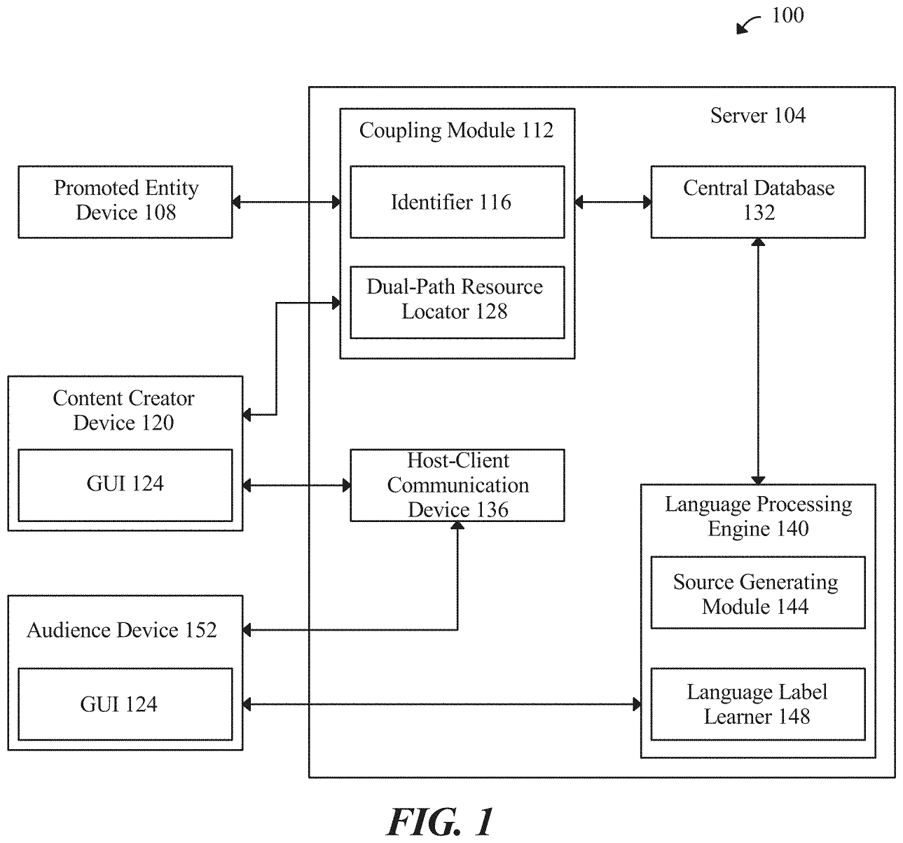

Referring now to FIG. 1, an exemplary embodiment of streaming network 100 is illustrated. Streaming network 100 may include a computing device. Streaming network 100 may include a processor. Processor may include, without limitation, any processor described in this disclosure. Processor may be included in a computing device. Computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing devices operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented, as a non-limiting example, using a “shared nothing” architecture.

Still referring to FIG. 1, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, a streaming network, system, apparatus, and the like may include at least a processor and a memory communicatively connected to the at least a processor, the memory containing instructions configuring the at least a processor to perform one or more processes described in this disclosure. Computing devices including a memory and at least a processor are described in further detail in this disclosure.

Still referring to FIG. 1, as used in this disclosure, “communicatively connected” means connected by way of a connection, attachment or linkage between two or more relate which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Referring now to FIG. 1, an exemplary streaming network 100 is disclosed. In some embodiments, streaming network 100 may be capable of associating dual-path resource locators with streaming content. Such an exemplary streaming network 100 may be deployed using any embodiments of systems and/or elements thereof as described in U.S. Nonprovisional application Ser. No. 16/038,841, filed on Jul. 18, 2018, and entitled “A PLATFORM-AGNOSTIC THICK-CLIENT SYSTEM FOR COMBINED DELIVERY OF DISPARATE STREAMING CONTENT AND DYNAMIC CONTENT BY COMBINING DYNAMIC DATA WITH OUTPUT FROM A CONTINUOUS QUEUE TRANSMITTER,” the entirety of which is incorporated herein by reference. As a non-limiting example, any display of any datum or element as described in this disclosure, including display fragments and/or client-side variants as described in further detail below, may be effected using any display section, content viewing portions, bars, extensions, content layer elements, or the like, suitable for display of any element to be displayed in any manner described in U.S. Nonprovisional application Ser. No. 16/038,841; furthermore, any dual-path resource locator as described in further detail herein may be included in and/or linked to any client redirection link as described in U.S. Nonprovisional application Ser. No. 16/038,841. Any streaming content may be provided according to any embodiment of any process, system, step, and/or component as described in U.S. Nonprovisional application Ser. No. 16/038,841; for instance, streaming may be performed by transmission of quanta of data over a network while continuously displaying such quanta in audio or visual form, by storing some such quanta of data in a buffer prior to display, and/or by storage on any device such as server 104 and/or audience device as a file to be played on demand. Such a computing system 500 may be a single computing system or a network of such or similar computing systems (e.g., a wide-area network, a global network (such as the Internet), and/or a local area network, among others), that is generally: 1) programmed with instructions for performing steps of a method of the present disclosure; 2) capable of receiving and/or storing data necessary to execute such steps; and 3) capable of providing any user interface that may be needed for a user such as an audience member to interact with devices on the streaming network system. Those skilled in the art will readily appreciate that aspects of the present disclosure can be implemented with and/or within any one or more of numerous devices, ranging from self-contained devices, such as a smartphone, tablet, computer, laptop computer, desktop computer, server, or web-server, to a network of two or more of any of these devices. For example, streaming network 100 and other aspects of server 104 may be contained within and/or implemented by one or more in-house systems, a centralized server, or a decentralized network of devices and/or software, among other implementations that will become readily apparent after reading this disclosure in its entirety. In some embodiments, depending on specific implementation, one or more steps of a method incorporating features/functionality disclosed in this disclosure may be implemented substantially in real-time.

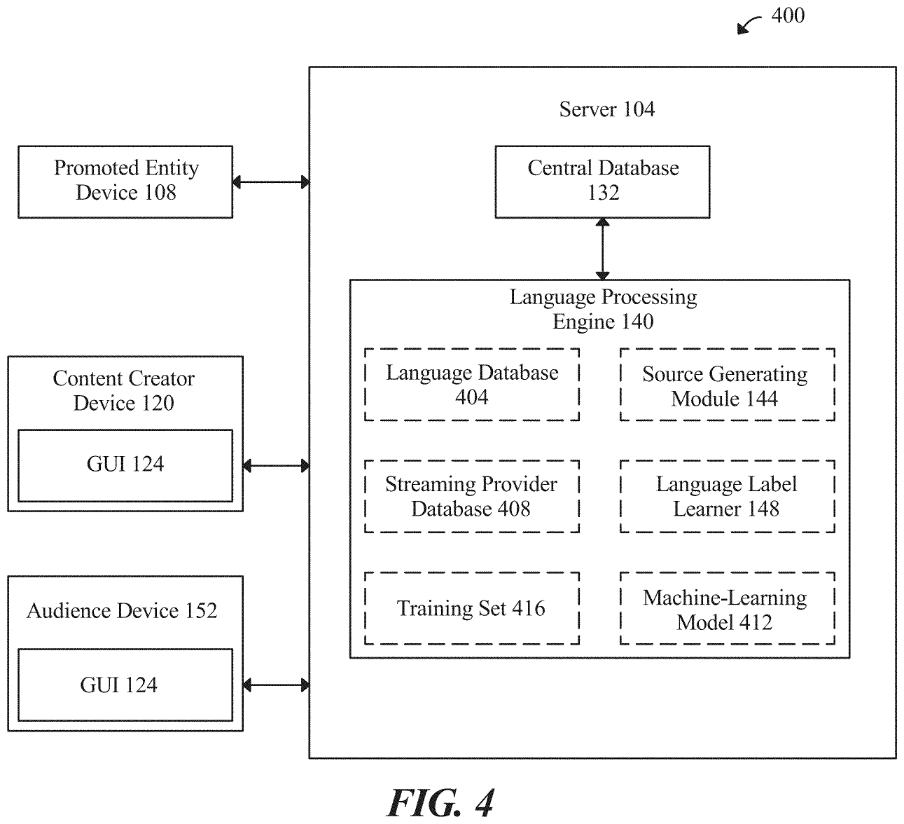

Still referring to FIG. 1, in some embodiments, streaming network 100 may include at least a server 104. In some embodiments, at least a server 104 may include a computing device as described below in reference to FIG. 4, including without limitation a microcontroller, microprocessor, digital signal processor (DSP) and/or system on a chip (SoC) as described below in reference to FIG. 4. Computing device may include, be included in, and/or communicate with a mobile device such as a mobile telephone or smartphone. At least a server 104 may include a single computing device operating independently, or may include two or more computing device operating in concert, in parallel, sequentially or the like; two or more computing devices may be included together in a single computing device or in two or more computing devices. At least a server 104 may connect to, communicate with, or otherwise interact with one or more additional devices as described below in further detail via a network interface device. Network interface device may be utilized for connecting a at least a server 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. At least a server 104 may include but is not limited to, for example, a at least a server 104 or cluster of computing devices in a first location and a second computing device or cluster of computing devices in a second location. At least a server 104 may include one or more computing devices dedicated to data storage, security, distribution of traffic for load balancing, and the like. At least a server 104 may distribute one or more computing tasks as described below across a plurality of computing devices of computing device, which may operate in parallel, in series, redundantly, or in any other manner used for distribution of tasks or memory between computing devices. At least a server 104 may be implemented using a “shared nothing” architecture in which data is cached at the worker, in an embodiment, this may enable scalability of method 200 and/or computing device.

Still referring to FIG. 1, streaming network 100 may include a promoted entity device 108. As used in this disclosure, a “promoted entity device” is a device operated by an entity, or a user associated with an entity, that receives or attempts to receive a promotion. A promoted entity device may include, in non-limiting examples, a smartphone operated by a store owner wishing to advertise products, a computer operated by an online retailer wishing to promote a website, and a tablet operated by an employee tasked with promoting a website. A promotion may include an advertisement. In some embodiments, promoted entity device 108 may be configured to transmit information to a coupling module 112 of the at least a server 104. Promoted entity device 108 may be related to individuals, brokers, and/or other businesses that utilize identifiers to promote services during a continuous data stream of a content creator. At least an identifier 116 as used in this disclosure includes a first path to the promoted entity device 108, which may include, without limitation, a uniform resource locator (“URL”), as well as at least a set of instructions for at least a process to be performed on the promoted entity device 108 and at least a set of rules associated with the at least a set of instructions to be accepted by a content creator before the at least a process to be performed in a data structure, such as a historical data bin as described further below. The at least an identifier 116 may include at least a keyword for triggering display of a textual element during a continuous data stream, which upon selection by an audience member may direct the graphical user interface of a device to the promoted entity device 108 interface. Streaming network 100 may include a content creator device 120. As used in this disclosure, a “content creator device” is a device operated by a content creator, or a user associated with a content creator. A content creator device may include, in non-limiting examples, a smartphone operated by a content creator, and a computer operated by an employee of a content creator. In some embodiments, a content creator may include a content creator that provides continuous data streams to audience members. In some embodiments, a content creator may stream video, audio, or video and audio content to audience members. At least a set of rules may include without limitation terms set by promoted entity device 108 involving monetary compensation for the accepting content creator using a content creator device 120 for allowing the textual element to be displayed during a continuous data stream after said trigger word is spoken by the content creator and for every audience member which selects the textual element and is directed from the continuous data stream to the promoted entity device 108 interface. Acceptance of rules associated with at least an identifier 116 may be considered as an agreement between promoted entity device 108 and content creator device 120.

Still referring to FIG. 1, selection and agreement to rules of at least an identifier 116 by content creator of content creator device 120 may be performed on a graphical user interface (GUI) 124, which may provide a content creator with a field to indicate a selection of at least an identifier provided by a promoted entity device 108 via coupling module 112. Selection and agreement to rules of at least an identifier 116 may then be sent to coupling module 112 of the at least a server 104 wherein a dual-path resource locator 128 is generated. Dual-path resource locator 128 identifies a first path to the promoted entity device 108 based on the selection of the at least an identifier and a second path to the content creator device 120 which performed the selection; as a non-limiting example, first path, may include a URL, directed towards promoted entity device 108 and second path may include URL, associated with content creator device 120; first path and/or second path may be contained in dual-path resource locator 128 and/or associated therewith via a data store, historical data bin, and/or data structure linking dual-path resource locator 128 with first path and/or second path. For instance, and without limitation, one or both of first path and second path may be identified within system 100 via a code or other datum that may be used to retrieve and/or navigate to first path and/or second path, and which may be included in, associated with, or linked to dual-path resource locator 128. Dual path resource locator 128 may be stored in a central database 132 on the at least a server 104 in a multitude of forms including a data-structure or as described further below.

Still referring to FIG. 1, content creator device 120 may provide a continuous data stream of audio content to listeners on a server via a Host-client communication device 136 on the at least a server 104. Host-client communication device 136 may include any suitable hardware or software module. Host-client communication device 136 may be designed and configured to receive a continuous data stream from a content creator device 120 and transmit the audio content of the continuous data stream to audience device 152. Further, host-client communication device 136 transmits the continuous data stream as a corpus of data to a language processing engine 140 on server 104. In an embodiment, host-client communication device 136 may transmit a continuous data stream to an audience device 152 operated by an audience member and/or to language processing engine 140 on server 104.

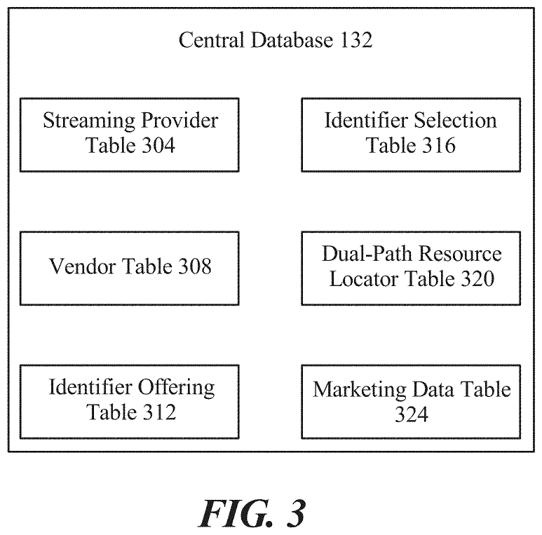

Still referring to FIG. 1, host-client communication device 136 may take in audio content from a content creator device 120 and distribute the content to listeners on and/or in communication with at least a server 104. Audio content may be further processed through a language processing engine 140 for detection of any data elements contained in a dual-path resource locator 128 which may be stored in a central database 132 on the at least a server 104. Language processing engine 140 may take in a continuous corpus of data, defined as any collection of textual data elements, during a continuous data stream from the Host-client communication device 136 and generate, using a machine learning algorithm, a plurality of data elements. At least a data element may include information including but not limited to at least an auditory cue which when spoken and/or otherwise entered in a continuous data stream triggers generating of at least a textual output associated with and/or identifying dual-path resource locator 128. Language processing engine 140 may match at least a data element from the plurality of data elements within the corpus of data to generate the at least a textual output using a source generating module 144 on at least a server 104; this may be performed, without limitation, using a machine-learning algorithm as described in further detail below. Source generating module 144 may generate at least a textual output by generating at least a query using the continuous data steam, determine that the at least a query includes at least a data element relating to the dual-path resource locator, and generate at least a textual output as a function of the at least a query; query may be any collection of data including the at least a data element. At least a textual output may be generated by a language label learner 148 operating on at least a server 104. Briefly, language label learner 148 may take as input the at least a data element; language label learner 148 may be designed and configured to generate at least a label output as a function of at least a data element and a training set correlating to first path of promoted entity device 108 to an interactive textual element, receive from language label learner 148, at least a label output, and generate the textual output using the at least a label output. A more detailed description relating to language processing engine, machine learning algorithm, training data, and the like is below in reference to FIG. 3.

Still referring to FIG. 1, following detection of at least a data element relating to the dual-path resource locator 128 and generation of a textual element, dual-path resource locator 128 is associated with the continuous data stream. Association may involve, without limitation, generating a code corresponding to at least a textual output by source generating module 144 and transmitting the code to at least an audience device 152. Audience device 152 may contain a graphical user interface (GUI) 124 for interacting with textual output and/or data, including without limitation any other contents of a continuous data stream, and may be any of the devices mentioned above. Upon audience interaction with textual output graphical user interface of audience device 152 may be directed to first path. Association of the dual-path resource locator 128 with the continuous data stream is described in more detail below in FIG. 4.

Still referring to FIG. 1, data incorporated in and associated with dual-path resource locator 128 may be incorporated in one or more databases. As a non-limiting example, one or more elements of dual-path resource locators associated with third-party devices may be stored in and/or retrieved from a central database 132 on server 104. A central database 132 may include any data structure for ordered storage and retrieval of data, which may be implemented as a hardware or software module. A central database 132 may be implemented, without limitation, as a relational database, a key-value retrieval datastore such as a NOSQL database, or any other format or structure for use as a datastore that a person skilled in the art would recognize as suitable upon review of the entirety of this disclosure. Central database 132 may include a plurality of data entries with information related to possible data elements as described above. Data entries may include, without limitation, promoted entity information (promoted entity names, remote devices, markets, marketing costs, or the like), content creator information (content creator name, remote devices, marketing costs, or the like), paths such as URLs, textual elements, or the like which may be associated with data elements of dual-path resource locators. Information in data entries may further be associated with general marketing trends and marketing trends of the content creator. Data entries in a central database 132 may be flagged with or linked to one or more additional elements of information, which may be reflected in data entry cells and/or in linked tables such as tables related by one or more indices in a relational database. Additional plausible processing of data entries in central database 132 is further described in FIG. 4 with reference to language processing engine 140.

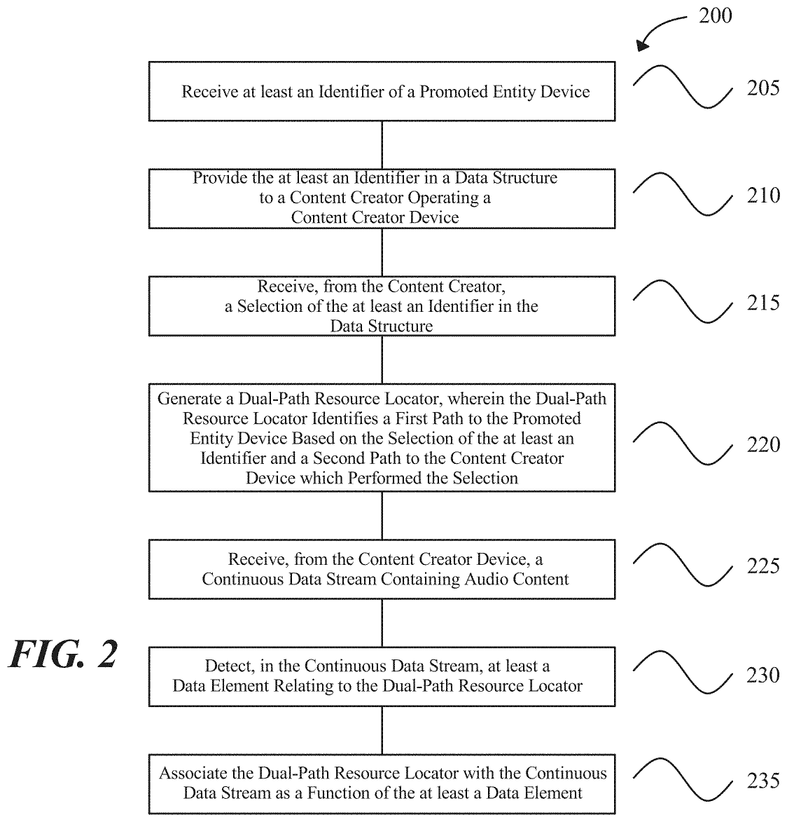

Referring now to FIG. 2, exemplary method 200 includes step 205 at which at least a server 104 receives at least an identifier 116 of a promoted entity device 108. Receiving at least an identifier may include receiving a first path to a promoted entity device 108. Receiving at least an identifier may include receiving at least a set of instructions for at least a process to be performed on the promoted entity device 108. Promoted entity device 108 may be linked, as a non-limiting example, to a vendor who provides a service. At least an identifier may include any information associated with promoted entity device and/or any entity, such as a promoted entity, linked thereto including promoted entity name, a service provided by promoted entity, a keyword or other textual datum for triggering a textual output during an audial or other continuous data stream, monetary compensation for a content creator allowing for the textual output to be associated with their continuous data stream, a path such as without limitation a URL to a location of the third-party device such as a promoted entity website, a set of rules for how an association during a continuous data stream, for instance as described below, may take place, and the like as mentioned above.

Still referring to FIG. 2, at step 210, at least a server 104 provides the at least an identifier 116 in a data structure, such as a historical data bin as described further below, to a content creator operating a content creator device 120. Content creator here may be provided the at least an identifier 116 in any suitable data structure such as without limitation, a table, a memory address, an object in object-oriented programming, a variable or data type, or the like. Providing at least an identifier may include providing a user interface, such as a graphical user interface as described above, for selection of the at least an identifier. Content creator and/or content creator device 120 may select at least an identifier 116 from the data structure; for instance by entering instructions or passing an argument and/or datum indicating acceptance; acceptance may indicate acceptance of rules and terms of an agreement for having a promoted entity textual output displayed during a continuous data stream provided by and/or from content creator and/or content creator device 120. A non-limiting example of this process is described below.

Still referring to FIG. 2, at step 215, at least a server receives, from content creator device 120 and/or content creator operating the content creator device 120, a selection of at least an identifier in the data structure. Content creator device 120 selection of at least an identifier 116 may be transmitted to the at least a server 104 such as in step 215; at least a server 104 and/or one or other element of system may verify that content creator accepts the terms of such promoted entity. In a non-limiting example, transmission and/or acceptance of selection may be contingent on such acceptance, and/or upon one or more security steps such as authentication of content creator device 120, content creator, or other devices, persons, and/or entities in or interacting with system 100. Receiving a selection of at least an identifier may include receiving a second path to content creator device 120, which may include any such path as described in this disclosure.

Still referring to FIG. 2, at step 220, at least a server 104 generates a dual-path resource locator 128. A “dual-path resource locator” as used in this disclosure is a data structure, which may include any collection of data stored according to any process, using any protocol, data storage facility, object, or other data storage process as described in this disclosure, identifying at least a first path, which may be and/or include any path as described in this disclosure, to a promoted entity device 108 and a second path, which may be and/or include any path as described in this disclosure, to a content creator device 120; promoted entity device 108 may be a distinct device from content creator device 120, and/or first path may be a distinct path from second path. Dual-path resource locator 128 identifies a first path to the promoted entity device 108, which identification may be based on the selection of the at least an identifier 116, and a second path to the content creator device 120 which performed the selection. Such paths may include any paths as described in this disclosure, including without limitation a URL associated with promoted entity device 108 and content creator device 120. Generating dual-path resource locator may include generating one or more uniform resource locators associated with promoted entity device 108. All data associated with dual-path resource locator 128 may be stored on at least a server in a data structure or in central database 132. Dual-path resource locator 128 may include, without limitation, one or more elements of semantic and/or numerical information that a device and/or person may use to identify and/or navigate to a network address, URL, or other identifier of a device and/or set of devices associated with, for instance, a content creator, a store, an advertiser, or the like.

Further referring to FIG. 2, dual-path resource locator may include, in a non-limiting example, one or more resource locator elements. A “resource locator element” may include, without limitation, an element of semantic, textual, and/or numerical data identifying a content creator, a site, entity, organization, and/or program associated with a content creator, a discount associated with a content creator, a product, service, or other salable element associated with a store and/or advertiser, a discount associated with a product, service, or other salable element associated with a store and/or advertiser, and/or a discount associated with both a content creator, site, entity, organization, and/or program associated with a content creator and with a product, service, or other salable element associated with a store and/or advertiser. For instance, and without limitation, a resource-locator element may include a “promotional code” and/or “promo code” that a user may enter to redeem a discount, free shipping, faster shipping, customization, limited edition, or other attribute associated with a product, service, or other salable element, a store and/or advertiser associated therewith, and/or the sale, shipping, transfer, and/or negotiation thereof. A resource locator element may alternatively or additionally be stored and/or transmitted separately from and/or with a

Still referring to FIG. 2, at step 225, at least a server 104 receives a continuous data stream from a content creator device 120; the continuous data stream may include a continuous data stream containing audio content. In a non-limiting illustration, individuals with audience devices 152 connected to at least a server 104 may listen to continuous data stream and interact with such content through a graphical user interface on such audience devices 152, for instance as described above. At least a server 104 may stream continuous data stream to one or more audience devices 152, for instance by transmitting packets received with and/or in continuous data stream to the one or more audience devices 152.

Still referring to FIG. 2, at step 230, at least a server 104 detects at least a data element in the continuous data stream. At least a data element relates to a dual-path resource locator 128 stored in central database 132, where relating to the dual-path resource locator 128 signifies identifying dual-path resource locator using any suitable identifier as described in this disclosure; identifier may include a textual datum and/or a spoken word, phrase, or other identifiable element of audio content. An example of the detection and rules for display may be seen here, as a non-limiting example, starting with an identifier associated with promoted entity “Star Coffee” who has elected “Star coffee” as the keyword/key-phrase for triggering display of their textual output. Continuing the above-described example, promoted entity may also have elected display of textual output for 2 minutes during a live stream after the content creator says “Star coffee”; remuneration, such as a payment of $100 to content creator by Star Coffee, and/or $20 for every audience member listening to the continuous data stream who selects the textual output and is directed to the promoted entity's site which is run by a third-party remote device, may be provided. Rules of an accepted agreement may contain more than one identifying keyword/key-phrase as well. Using an example in a similar non-limiting fashion with “all of our coffee sponsors,” “Star Coffee,”, and “Sun Coffee”; content creator may, in a non-limiting example, say “Thanks to all of our coffee sponsors” and textual outputs for Star Coffee and Sun Coffee may either and/or both be displayed on audience device 152 if associated with the live stream on server 104. This may be referred to as a category that relates to multiple data elements of multiple identifiers. Persons skilled in the art, upon reviewing the entirety of this disclosure, will be aware of various additional forms and/or examples thereof that identification may take. Detection may include without limitation, conversion of audio content and/or data to text using speech-to-text software, modules, and/or algorithms; such detection may include matching initially converted words to homonyms and/or near homonyms using a machine-learning process, which may be any as described below, trained using training data as described below that includes a plurality of entries correlating textual data to similar sounding words that may be mistakenly identified by speech-to-text facilities as described above. Such training data may be input by users such as audience members, collected by error detection and/or as a result of user feedback, or the like.

Still referring to FIG. 2, detection of at least a data element may involve use of a language processing engine, associated components, and a language processing algorithm as mentioned in FIG. 2 above. As a non-limiting example, detecting at least a data element relating to the dual-path resource locator of the continuous data stream may include extracting, by a language processing engine operating on the at least a server, a corpus of textual data from the continuous data stream. Language processing engine may generate, for instance and without limitation using at least a machine-learning algorithm and/or any other process described in this disclosure for a language processing engine, a plurality of data elements. Language processing engine may match, for instance by using at least a machine-learning algorithm and/or any other process described in this disclosure for matching textual data to other textual data, including without limitation vector-similarity tests or the like, at least a data element from the plurality of data elements in the corpus of data to at least an identifier of the promoted entity device 108 of the dual-path resource locator. A source generating module on the at least a server may generate at least a textual output from the matched at least a data element of the continuous data stream, and source generating module and/or at least a server may detect at least a data element relating to the dual-path resource locator as a function of the at least a textual output.

Still referring to FIG. 2, in a non-limiting example, language processing engine may monitor all words spoken by the content creator during a continuous data stream and process the corpus of data as mentioned in the description of FIG. 1; words may, as a non-limiting example, be converted to text using speech-to-text software, modules, and/or algorithms. Using the example previously mentioned, when “Star coffee” is said by the content creator language processing engine may determine, for instance via comparison, matching, or other processes as described in this disclosure, that this phrase is a stored data element in dual-path resource locator in a data structure and/or data storage facility such as without limitation central database 132 and create a textual output based on the information found there. Further language processing specifics can be found below in the description of FIG. 3.

Still referring to FIG. 2, at step 235, at least a server 104 associates dual-path resource locator 128 with continuous data stream as a function of at least a data element; this may include, without limitation, displaying the interactive textual output on audience devices 152. For instance, at least a server 104 and/or source generating module 144 may transmit at least a textual output to at least an audience device 152 communicating with the at least a server 104, which communication may include communication during and/or involving receiving the continuous data stream; at least an audience device 152 may include contains a graphical user interface as described in this disclosure for interacting with the textual output. In keeping with the previously mentioned example, and by way of illustration only, the phrase “Star coffee” will trigger the display of the appropriate textual output associated with that promoted entity on audience devices 152 that are connected to the at least a server 104 and are streaming the continuous data stream for two minutes, wherein audience members may select the textual output and be redirected to a URL associated with the promoted entity device 108.

Referring now to FIG. 3, an exemplary embodiment of a central database 132 is illustrated. In general, central database 132 may organize data stored in the central database 132 according to one or more database tables. Central database 132 may include, as a non-limiting example, a streaming provider table 304. Streaming provider table 304 may include a table listing information related to a content creator including provider name, path to at least a remote device used by the provider for selection of at least an identifier of a third-party remote device via first path, path to at least a remote device used by the provider for hosting of a continuous data stream via second path, marketing costs, or the like. As a further non-limiting example, central database 132 may include a vendor table 308 which may list at least a promoted entity name, path to at least a remote device used by the promoted entity for sending at least an identifier to a server associated with a content creator via a path such as second path, path to at least a remote device associated with a textual element of a dual-path resource locator via a path, which may include any path as described in this disclosure including without limitation a URL, marketing costs, or the like. As another non-limiting example, central database 132 may contain an identifier offering table 312 which may list the at least an identifier from a promoted entity remote device offered to a content creator, information associated with the at least an identifier further including: a path to the remote device of a promoted entity via a path such as first path and/or any path suitable for use as first path; at least a set of instructions for at least a process to be performed on the remote device of a promoted entity; at least a set of rules associated with the at least a set of instructions to be accepted by the content creator before the at least a process is to be performed; at least a keyword for triggering display of a textual element during the continuous data stream of the content creator; monetary compensation for the accepting content creator using a content creator device 120 for allowing the textual element be displayed during the continuous data stream after said trigger word is spoken by the content creator and for every listener which selects the textual element and is directed from the continuous data stream to an interface of a promoted entity device 108 of the promoted entity; or the like. As a further example, also non-limiting, central database 132 may include an identifier selection table 316 which may list the at least an identifier for which the content creator has selected for association with the continuous data steam and where accompanying rules from promoted entity have been accepted, or the like. As a further non-limiting example, central database 132 may include a dual-path resource locator table 320 which may list second path, first path, a keyword for triggering a textual element display during the continuous data stream, or the like. Central database 132 may also include, as another non-limiting example, a marketing data table 324 which may list revenue generated by current and past dual-path resource locators for a content creator, revenue generated in the general marketplace for dual-path resource locators associated with specific promoted entities, or the like. Persons skilled in the art, upon reviewing the entirety of this disclosure, will be aware of various ways in which data entries in a central database 132 may reflect and store information relating to a promoted entity device 108, identifier 116, content creator device 120, dual-path resource locator 128, and the like consistently within this disclosure with reference to FIG. 1.

Now referring to FIG. 4, language processing engine 140 may include any suitable hardware or software module. Language processing engine 140 is designed and configured to receive at least a corpus of data from a continuous data stream and extract a plurality of data elements. At least a request for data element detection in a continuous data stream may be received from content creator device 120 via a Host-client communication device 136. Content creator device 120 may include, without limitation, a display in communication with server 104; display may include any display as described in this disclosure. Content creator device 120 may include an additional computing device, such as a mobile device, laptop, desktop computer, or the like; as a non-limiting example, content creator device 120 may include a computer and/or workstation operated by a user such as a content creator.

With continued reference to FIG. 4, language processing engine 140 may extract data elements describing significant categories of device data, relationships of such categories to data elements, and/or significant categories of data elements from one or more continuous data streams. Data elements are related to at least a dual-path resource locator on the server and categories of data elements may relate to the same promoted entity of multiple resource locators or promoted entities in which have similar resource locators and are able to have textual outputs displayed simultaneously with a common word/phrase which define a common category. Language processing engine 140 may be configured to extract, from the one or more continuous data streams, one or more words. One or more words may include, without limitation, strings of one or characters, including without limitation any sequence or sequences of spoken letters, numbers, punctuation, diacritic marks, engineering symbols, chemical symbols and formulas, spaces, whitespace, and other symbols. This extracted information may be referred to in textual data. Textual data may be parsed into tokens, which may include a simple word (sequence of letters separated by whitespace) or more generally a sequence of characters as described previously. The term “token,” as used in this disclosure, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 4, language processing engine 140 may compare extracted words to categories of data recorded on at least a server 104, one or more data elements recorded on at least a server 104, and/or one or more categories of data elements recorded on at least a server 104; such data for comparison may be entered on at least a server 104 as described above using data inputs from corpuses of data from a continuous data stream or the like. In an embodiment, one or more categories may be enumerated, to find total count of mentions in such corpuses of data. Alternatively or additionally, language processing engine 140 may operate to produce a language processing model. Language processing model may include a program automatically generated by at least a server 104 and/or language processing engine 140 to produce associations between one or more words extracted from at least a corpus of data and detect associations, including without limitation mathematical associations, between such words, and/or associations of extracted words with categories of data elements, relationships of such categories to data elements and/or categories of data elements. Associations between language elements, where language elements include for purposes in this disclosure extracted words, categories of device data, relationships of such categories to data elements, and/or categories of data elements may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of device data, a given relationship of such categories to data elements, and/or a given category of data elements. As a further example, statistical correlations and/or mathematical associations may include probabilistic formulas or relationships indicating a positive and/or negative association between at least an extracted word and/or a given category of user data, a given relationship of such categories to data elements, and/or a given category of data elements; positive or negative indication may include an indication that a given corpus of data is or is not indicating a data element of a dual-path resource locator or a data element within a category of dual-path resource locators. For instance, and without limitation, a negative indication may be given to a content creator if an audio cue is given and not related to a dual-path resource locator in the database on the server, such as “no such vendor found,” whereas a positive indication may be given to a content creator if an audio cue is given and is associated with a dual-path resource locator in the database on the server, thus displaying the textual output of a promoted entity as described above with “Star Coffee.” Whether a phrase, sentence, word, or other textual element in a corpus of data or corpus of corpuses of data constitutes a positive or negative indicator may be determined, in an embodiment, by mathematical associations between detected words, comparisons to phrases and/or words indicating positive and/or negative indicators that are stored in memory at least a server 104, or the like.

Still referring to FIG. 4, language processing engine 140 and/or at least a server 104 may generate the language processing model by any suitable method, including without limitation a natural language processing classification algorithm; language processing model may include a natural language process classification model that enumerates and/or derives statistical relationships between input term and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used in this disclosure are statistical models with inference algorithms that that may be applied to the models. In such models, a hidden state to be estimated may include an association between an extracted word category of device data, a given relationship of such categories to data elements, and/or a given category of data elements. There may be a finite number of categories of device data, given relationships of such categories to data elements, and/or data elements to which an extracted word may pertain; an HMM inference algorithm, such as the forward-backward algorithm or the Viterbi algorithm, may be used to estimate the most likely discrete state given a word or sequence of words. Language processing engine 140 may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 4, language processing engine 140 may generate a vector space, which may be a collection of vectors, defined as a set of mathematical objects that may be added together under an operation of addition following properties of associativity, commutativity, existence of an identity element, and existence of an inverse element for each vector, and may be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which may be computed using a dot product of the two vectors divided by the lengths of the two vectors. Degree of similarity may include any other geometric measure of distance between vectors.

Still referring to FIG. 4, language processing engine 140 may use one or more corpuses of data to generate associations between language elements from a continuous data stream received by the language processing engine 140, and at least a server 104 may then use such associations to analyze words extracted from one or more corpuses of data and determine that the one or more corpuses of data indicate a data element associated with a dual-path resource locator 128 stored in a central database 132. In an embodiment, at least a server 104 may perform this analysis using a selected set of significant corpuses of data, such as corpuses of data identified by a continuous data stream or the like via content creator device 120 using a graphical user interface as described in this application. Corpuses of data may be entered into at least a server 104 by being uploaded by the content creator using content creator device 120 via a continuous data stream or other persons using, without limitation, file transfer protocol (FTP) or other suitable methods for transmission and/or upload of corpuses of data; alternatively or additionally, where a corpus of data is identified by a citation, a uniform resource identifier (URI), URL, or other datum permitting unambiguous identification of the corpus of data, at least a server 104 may automatically obtain the corpus of data using such an identifier, for instance by submitting a request to a database or compendium of corpuses of data such as JSTOR as provided by Ithaka Harbors, Inc. of New York.

Continuing to refer to FIG. 4, whether an entry indicating significance of a category of device data, a given relationship of such categories to data elements, and/or a given category of data elements is entered via graphical user interface, alternative submission means, and/or extracted from a corpus of data or body of corpuses of data as described above, an entry or entries may be aggregated to indicate an overall degree of significance. For instance, each category of device data, a given relationship of such categories to data elements, and/or a given category of data elements may be given an overall significance score; overall significance score may, for instance, be incremented each time an expert submission and/or paper indicates significance as described above. Persons skilled in the art, upon reviewing the entirety of this disclosure will be aware of other ways in which scores may be generated using a plurality of entries, including averaging, weighted averaging, normalization, and the like. Significance scores may be ranked; that is, all categories of user data, relationships of such categories to data elements, and/or categories of data elements may be ranked according significance scores, for instance by ranking categories of user data, relationships of such categories to data elements, and/or categories of data elements higher according to higher significance scores and lower according to lower significance scores. Categories of user data, relationships of such categories to data elements, and/or categories of data elements may be eliminated from current use if they fail a threshold comparison, which may include a comparison of significance score to a threshold number, a requirement that significance score belong to a given portion of ranking such as a threshold percentile, quartile, or number of top-ranked scores. Significance scores may be used to filter outputs as described in further detail below; for instance, where a number of outputs are generated and automated selection of a smaller number of outputs is desired, outputs corresponding to higher significance scores may be identified as more probable and/or selected for presentation while other outputs corresponding to lower significance scores may be eliminated.

Still referring to FIG. 4, at least a server 104 may detect further significant categories of device data, a given relationship of such categories to data elements, and/or a given category of data elements using machine-learning processes as described in further detail below; such newly identified categories may be added to pre-populated lists of categories, lists used to identify language elements for language learning module, and/or lists used to identify and/or score categories detected in corpuses of data, as described above.

With continued reference to FIG. 4, language processing engine 140 may receive a training set correlating data elements to textual outputs. Training set may be received in the form of training data. Training data, as used in this disclosure, is data containing correlations that a machine-learning process may use to model relationships between two or more categories of data elements. For instance, and without limitation, training data may include a plurality of data entries, each entry representing a set of data elements that were recorded, received, and/or generated together; data elements may be correlated by shared existence in a given data entry, by proximity in a given data entry, or the like. Multiple data entries in training data may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data according to various correlations; correlations may indicate causative and/or predictive links between categories of data elements, which may be modeled as relationships such as mathematical relationships by machine-learning processes as described in further detail below. Training data may be formatted and/or organized by categories of data elements, for instance by associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements; for instance, and without limitation, training data may be provided in fixed-length formats, formats linking positions of data to categories such as comma-separated value (CSV) formats and/or self-describing formats such as extensible markup language (XML), enabling processes or devices to detect categories of data.

Alternatively or additionally, and still referring to FIG. 4, training data may include one or more elements that are not categorized; that is, training data may not be formatted or contain descriptors for some elements of data. Machine-learning algorithms and/or other processes may sort training data according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name and/or a description of a medical condition or therapy may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below.

Continuing to refer to FIG. 4, in an embodiment, language processing engine 140 may be configured, for instance as part of receiving a training set 418, to associate at least a data element with at least a significant category associated with at least a dual-path resource locator from a list of significant categories of data elements. Significant categories of data elements may be acquired, determined, and/or ranked as described above. As a non-limiting example, data elements may be organized according to relevance to and/or association with a list of dual-path resource locators. A list of significant dual-path resource locators may include, without limitation, those that were accepted by the content creator for having a promoted entity's textual element be displayed during a live stream. The list of significant dual-path resource locators may be updated with the content creator accepting terms from third-party devices from new promoted entities or by updating the terms of current agreements, thus language processing engine 140 may modify list of significant categories to reflect changes.

Still referring to FIG. 4, data incorporated in training set 418 may be incorporated in one or more databases. As a non-limiting example, one or more data elements of dual-path resource locators associated with third-party devices may be stored in and/or retrieved from a language database 404, with language database 404 extracting some information from data entries contained in central database 132. A language database 404 may include any data structure and/or data storage suitable for use as a central database 132 as described above. Language database 404 may be more specifically associated with data entries involving general marketing trends and/or audience member interaction with textual outputs from past interactions for formulations of conclusions regarding likelihood of audience member interaction. Such conclusions may have been generated by language processing engine 140 in previous iterations of methods. Data entries in a language database 404 may be flagged with or linked to one or more additional elements of information, which may be reflected in data entry cells and/or in linked tables such as tables related by one or more indices in a relational database; one or more additional elements of information may include data associating at least a data element with one or more dual-path resource locators, and/or information related to data entries mentioned above. Additional elements of information may include descriptions of particular methods used to extract data elements, matching such data elements with a dual-path resource locator, and associating the dual-path resource locator with a continuous data stream by the steaming content provider. Persons skilled in the art, upon reviewing the entirety of this disclosure, will be aware of various ways in which data entries in a language database 404 may reflect the data elements which relate to the original identifiers from a promoted entity device 108, the corresponding dual-path resource locator 128 stored in a central database 132, and a continuous data stream by the content creator device 120 consistently within this disclosure.

Referring again to FIG. 4, language processing engine 140 and/or another device in language processing engine 140 may populate one or more fields in language database 404 using content creator input from content creator device 120, which may be extracted or retrieved from a streaming provider database 408. A streaming provider database 408 may include any data structure and/or data store suitable for use as a central database 132 and language database 404 as described above. Streaming provider database 408 may include data entries reflecting one or more content creator submissions of data such as may have been submitted according to any process described above in reference to FIG. 2, including without limitation by using graphical user interface (GUI) 124. Streaming provider database 408 may include one or more fields generated by language processing engine 140, such as without limitation fields extracted from one or more corpuses of data as described above. For instance, and without limitation, one or more categories of data elements and/or related dual-path resource locators and/or categories of data elements as described above may be stored in generalized form in a streaming provider database 408 and linked to, entered in, or associated with entries in a language database 404. Dual-path resource locators may be stored and/or retrieved by language processing engine 140 and/or language database 404 and/or streaming provider database 408 and/or central database 132; all such storage devices listed may include any data structure and/or data storage components suitable for use as was described in the language database 404 above. Dual-path resource locators in any of the listed storage components may be linked to and/or retrieved following a keyword/key-phrase spoken by content creator using identifiers such as URI and/or URL data, promoted entity data, or the like; persons skilled in the art, upon reviewing the entirety of this disclosure, will be aware of various ways in which dual-path resource locators may be indexed and retrieved according to promoted entity, subject matter, speech, or the like as consistent with this disclosure.

Referring still to FIG. 4, language database 404 may be used to store label outputs used by language processing engine 140, including any label outputs correlated with data elements in training set 418 as briefly described above with more detail below. Label outputs may be linked to or refer to entries in language database 404 to which label outputs correspond. Linking may be performed by reference to historical data concerning relationships between a label output and a data element in language database 404 and may be determined by reference to a record in a streaming provider database 408 linking a given label output to a given category of data elements as described above.

Referring still to FIG. 4, training set 418 may be populated by retrieval of one or more data elements from language database 404 and/or steaming provider database 408. In an embodiment, entries retrieved from language database 404 and/or steaming provider database 408 may be filtered and/or selected via query to match one or more elements of information as described, so as to retrieve a training set 418 including data belonging to a given dual-path resource locator, data element, promoted entity, and/or other set, so as to generate outputs as described below that are tailored to a promoted entity device 108 with regard to what language processing engine 140 classifies as a data element of a dual-path resource locator during a continuous data stream. Persons skilled in the art, upon reviewing the entirety of this disclosure, will be aware of various ways in which data elements may be retrieved from language database 404 and/or steaming provider database 408 to generate a first training set to reflect specific promoted entity data pertaining to a selected promoted entity by a content creator of a content creator device 120, including without limitation a promoted entity's textual output during a continuous data stream with regard to what at least a dual-path resource locator contains as described in further detail below. Language processing engine 140 may alternatively or additionally receive a training set 418 and store one or more entries in language database 404 and/or steaming provider database 408 as extracted from elements of training set 418.

In an embodiment, and still referring to FIG. 4, language processing engine 140 may receive an update to one or more elements of data represented in training set 418, and may perform one or more modifications to training set 418, or to language database 404, and/or streaming provider database 408 as a result. For instance, a data element may turn out to have been erroneously recorded; language processing engine 140 may remove it from training set 418, language database 404, and/or streaming provider database 408 as a result. An agreement for presentation of a promoted entity's textual element during a continuous data stream by a content creator may also expire resulting in removal of a data element and/or dual-path resource locator.

Continuing to refer to FIG. 4, elements of data training set 418, language database 404, and/or streaming provider database 408 may have temporal attributes, such as timestamps; language processing engine 140 may order such elements according to recency, select only elements more recently entered for training set 418, or otherwise bias training sets, database entries, and/or machine-learning models as described in further detail below toward more recent or less recent entries. Persons skilled in the art, upon reviewing the entirety of this disclosure, will be aware of various ways in which temporal attributes of data entries may be used to affect results of methods and/or systems as described in this disclosure.

With continued reference to FIG. 4, language processing engine 140 may include a language label learner 148 operating on the language processing engine 140, the language label learner 148 designed and configured to generate the at least a label output as a function of the training set 418 and the at least a data element. Language label learner 148 may include any hardware and/or software module. Language label learner 148 is designed and configured to generate outputs using machine learning processes. A machine learning process, as used in this disclosure, is a process that automatedly uses a body of data known as “training data” and/or a “training set” to generate an algorithm that will be performed by a computing device/module to produce outputs given data provided as inputs; this is in contrast to a non-machine learning software program where the commands to be executed are determined in advance by a user and written in a programming language.

Still referring to FIG. 4, language label learner 148 may be designed and configured to generate at least a label output by creating at least a machine-learning model 412 relating data elements of dual-path resource locators to interactive textual elements of textual outputs using the training set 418. Language label learner 148 may be designed and configured to generate at least a label output using the machine-learning model 412 for generation of a textual output. At least a machine-learning model 412 may include one or more models that determine a mathematical relationship between data elements of dual-path resource locators to textual outputs. Such models may include without limitation models developed using linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithm used to generate machine-learning model 412 may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

In an embodiment, and continuing to refer to FIG. 4, language label learner 148 may generate a plurality of label outputs associated with multiple data elements relating to textual outputs from specific words/phrases extracted from a continuous data stream. For instance, where a keyword/key-phrase related to a data element may have multiple meanings or closely resemble other words/phrases during continuous data stream. In such a situation, language label learner 148 and/or language processing engine 140 may perform additional processes to resolve this ambiguity. Processes may include presenting multiple possible textual outputs relating to a word/phrase to content creator via GUI 124 of content creator device 120 to allow for the provider to manually make the decision to display a textual output to listeners or not. Alternatively or additionally, processes may include additional machine learning steps; for instance, where reference to a model generated using supervised learning on a limited domain has produced multiple mutually exclusive results and/or multiple results that are unlikely all to be correct, or multiple different supervised machine learning models in different domains may have identified mutually exclusive results and/or multiple results that are unlikely all to be correct. In such a situation, language label learner 148 and/or language processing engine 140 may operate a further algorithm to determine which of the multiple outputs is most likely to be correct. Results may be presented and/or retained with rankings, for instance to advise a content creator with which textual output have the most user interaction and thus are most reliable.

In continued reference to FIG. 4, upon a label output generation by language label learner 148, source generating module 144 may receive such label output to generate the textual output associated with the at least a data element and a dual-path resource locator 128. Display to a graphical user interface (GUI) 124 of audience device 152 may be done by source generating module 144 associating the generated textual output during a continuous data stream with code. Code, or “source code,” may be any collection of code, possibly with comments, written using a human-readable programming language, usually as plain text. The source code of a program is specially designed to facilitate the work of computer programmers, who specify the actions to be performed by a computer mostly by writing source code. The source code is often transformed by an assembler or compiler into binary machine code understood by the computer. The machine code might then be stored for execution at a later time. Alternatively, source code may be interpreted and thus immediately executed as may be done in this disclosure by source generating module 144 after receiving a label output. Textual output in this disclosure may contain a URL and an interactive textual element which is displayed on audience device 152, wherein an operator of audience device may interact/select the textual output during the continuous data stream and be directed to the associated URL of a promoted entity device 108. In doing so, content creator may be rewarded by the promoted entity of promoted entity device 108 for every time an audience member is directed from a content creator's continuous data stream to the path of the promoted entity device 108.

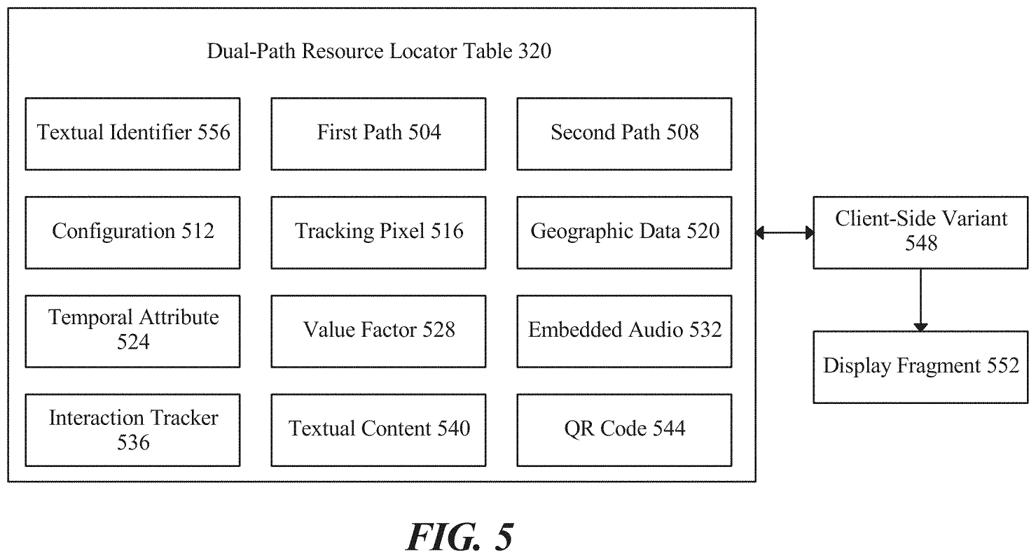

Referring now to FIG. 5, an exemplary embodiment of one or more elements that may be included in dual-resource locator 128 as described above is illustrated. Such attributes may, without limitation, be stored in dual-path resource locator table 320, for instance as described above in reference to FIG. 3, and/or in any other suitable data structure or memory resource as described in this disclosure. Attributes may include, without limitation, a textual identifier 556, which may include any string of textual data, which may be used in system 100 to identify dual-path resource locator 128 in system and/or to users. Attributes may include, without limitation, first path 504, which may include any first path as described above, including without limitation a URL; first path may further contain textual identifier 556 and/or a reference thereto. Attributes may include second path 508, first path 504, which may include any second path as described above, including without limitation a URL; second path may further contain textual identifier 556 and/or a reference thereto. Attributes may include configuration 512, which may include any element of data instructing promoted entity device 108 to act upon activation of dual-path resource locator, including, without limitation, transactions to be performed upon activation. Attributes may include a tracking pixel 516 for online activity and/or redemption at promoted entity device 108.

Still referring to FIG. 5, attributes may include one or more elements of navigational or geographical data 520, which may be used, for instance, to determine where audience device is located at a moment of activation or afterwards; for instance, one or more terms may require that audience device, as tracked by GPS or similar location and/or navigation systems, travel to a particular point such as a retail location or the like, prior to accessing value provided to a user of audience device. As a further non-limiting example, audience device and/or user thereof may be tracked using geographical data 520 to determine user activity subsequent to activation of dual-path resource locator 128; this may be used, without limitation, to modify configuration 512 based on one or more geographical factors. As an additional non-limiting example, configuration 512 may include an instruction for promoted entity device 108 to engage in a particular sequence of actions upon activation of dual-path resource locator 128 only if audience device is located in a particular location.

Continuing to refer to FIG. 5, one or more attributes may include a temporal attribute 524; temporal attribute may include an attribute indicating how one or more other attributes may change based on a period of time from creation, modification, and/or activation of dual-path resource. For instance, a temporal attribute 524 may indicate an “expiration date” after which promoted entity device 108 will not perform one or more actions, such as for instance, conferring a value upon an activating user, for that user and/or for all users, an “activation time” after which promoted entity device 108 will perform one or more actions, will modify one or more actions to be performed, or the like; this may cause system to modify configuration 512 automatically upon detecting that a period of time established in temporal attribute 524 has elapsed. One or more attributes may include at least a value factor 528, which may direct system 100 to modify a display of dual-path resource locator 128, such as without limitation changing display color, font, image, audio, or the like, upon a modification of any attribute as described in this disclosure. Such times, dates, and/or other information concerning promotions, sales, or the like may be detected using connector app and/or other application, module, and/or computing device such as without limitation server 104, via API connections, web-scraping, web-crawling, or the like.

Still referring to FIG. 5, attributes may include one or more elements of embedded audio 532, which may indicate and/or include at least an element of streaming data that may be provided upon display, activation, or any other activity involving dual-path resource locator 128; for instance, and without limitation, audio message may connected to a display such as a display bar or other such element and/or may include pausing a podcast to play the audio message and reconnecting to the podcast, causing it to continue streaming, at end. Audio message linked may describe, without limitation, a temporal attribute 524, such as “for the next 60 seconds only, you can get x for y”. Attributes may include an interaction tracker 532, which may record a history of activations, deployment, association with streaming content, and/or other use of dual-path resource locator 128, which may be tracked, for instance, according to times of occurrence, locations of occurrence, users and/or audience devices performing one or more actions, or the like. Attributes may include one or more additional elements of textual content 540, which may include any textual content to be displayed with dual-path resource locator, including without limitation on mouse-over, during activation, “on click” events, on touch events, events triggered by and/or after activation, automatic triggering push, voice-activation, or any other event handlers that may occur to a person skilled in the art upon reviewing the entirety of this disclosure. Attributes may include a QR code 544 or the like that may be linked to dual-path resource locator 128. Additional attributes may, e.g., specify particular users that may activate code, particular sequences of actions after or in conjunction with activation that may be required for a user to receive a value associated with dual-path resource locator 128, or the like. Attributes may include images and/or video content. Persons skilled in the art, upon reviewing the entirety of this disclosure, will be aware of various additional examples of data that may be included in attributes.

With continued reference FIG. 5, system 100 may be configured to include one or more subsets of attributes in a client-side variant 548, which may be deployed on a client-side device such as without limitation using a native application, a web browser, or the like. Client-side variant 548 may include some attributes while excluding other attributes or may include all attributes included for a given dual-path resource locator or set of dual-path resource locators. A set of dual-path resource locators may include a set identified may having identical or related attributes for any attribute field described above in dual-path resource locator table 320; as a non-limiting example, a set may be defined as containing records in dual-path resource locator table 320 having identical first path 504 and/or second path 508 data. As a further non-limiting example, a first record may be included in a set with at least a second record where each of the first record and the at least a second record has a first path 504 indicating a device or devices operated by the same entity, whether the indicated devices themselves are identical; in other words, a set may be made of dual-path resource locators having first paths 504 identifying identical entities. As a further non-limiting example, a first record may be included in a set with at least a second record where each of the first record and the at least a second record has a second path 508 indicating a device or devices operated by the same entity, whether the indicated devices themselves are identical; in other words, a set may be made of dual-path resource locators having second paths 508 identifying identical entities Transmission to audience device of client-side variant 548 may be performed automatically; for instance, and without limitation when user is receiving streaming content from, originating at previously, and/or associated with content creator device 120, a client-side variant containing a set of records having second paths 508 indicating content creator device 120 or devices associated with an entity operating content creator device 120 may automatically be transmitted to audience device. Alternatively or additionally, client-side variant 548 may be transmitted to audience device in response to a user interaction with audience device and/or user-entered command, such as a user activation of a dual-path resource locator 128, identifier, and/or a display fragment as described below, a user response in the affirmative to a prompt asking whether user wishes to display a particular client-side variant 548 and/or a set of records encompassed therein, or a user command requesting display of a particular client-side variant 548 and/or a set of records encompassed therein. A user action prompting display of client-side variant 548 may cause display of records transmitted to audience device in the past, and/or a particular set of records, such as the set of records associated with a content creator device 120 associated with currently playing or displaying streaming content, a set of records associated with a particular user, and/or a set of records matching on any attribute of dual-path resource locator table 320. A user may be able to “search” such records by entering a value and/or query; in response, server 104 and/or host-client communication device 136 may cause audience device 152 to display records having attributes matching the entered value and/or query.

Still referring to FIG. 5, server 104 and/or host-client communication device 136 may cause audience device 152 to display a display fragment 552; display occurs, without limitation, in response to detection of at least a data element relating to dual-path resource locator and/or as part of association of the dual-path resource locator with the continuous data stream as a function of at least a data element detected therein, as described above. Display fragment 552 may contain any attribute or combination of attributes described above for dual-path resource locator table. In an embodiment, server 104 and/or host-client communication device 136 may configure audience device 152 to generate and/or cause display of display fragment 552 containing at least a selected attribute. For instance, at least a selected attribute may include textual identifier 556. As another example, at least a selected attribute may include textual content 540. As another example, at least a selected attribute may include an image; an image may, for instance be stored as another attribute of table 320 and/or client-side variant 548. As another example, at least a selected attribute may include QR code. Selection of at least a selected attribute may be performed by any device or module performing such selection, using one or more context datums. One or more context datums may include, without limitation, user identity, geographic location, user history of interactions with dual-path resource locators, user history of interactions with streaming content, user preferences, or the like. As a non-limiting example, where geographic location of user, as detected using GPS or the like, indicates that user is located near to a retail establishment operated by an entity associated with promoted entity device 108, where “near to” means within some threshold distance or travel time, QR code may display; QR code may not display when geographical location is beyond threshold distance. Alternatively or additionally, any other attribute may display, including without limitation textual identifier 556, textual content 540, image data, or any other attribute; for instance, and without limitation, voice data may be displayed and/or output, including without limitation using any display elements described in this disclosure or in any disclosure incorporated by reference in this disclosure and/or by outputting and/or displaying any streaming content described in this disclosure and/or in any disclosure incorporated by reference in this disclosure. As another example, a history of user interaction with dual-path resource locators may indicate that a particular user and/or a user of audience device 152 activates dual-path resource locators more frequently when display fragment 552 includes an image than when it does not; at least a selected attribute may therefore include an image. Persons skilled in the art, upon reviewing the entirety of this disclosure, will be aware of various ways in which selection of at least a selected attribute may be performed consistently with this disclosure. Selection by user of display fragment 552, for instance by “clicking” on or touching such display fragment 552 as displayed on audience device 152, by entering a voice input that activates dual-path resource locator, or the like, may cause display of some or all of client-side variant 548, for instance by causing it to display on GUI from local storage on audience device or by fetching it and causing it to display after receipt.

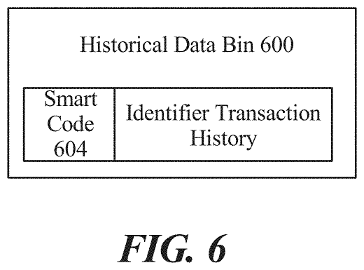

Referring now to FIG. 6, is an exemplary embodiment of a historical data bin 600. A “historical data bin,” as used in this disclosure, is a data structure containing identifiers 116 associated with and advertised to a user. Historical data bin 600 may be displayed and interacted with as a catalog through a graphical user interface on audience device connected to server 104. For example, a content creator may access historical data bin 600 on content creator device 120 and browse through the catalog to see all identifiers 116 they are a party to. A content creator may also be able to see identifiers 116 promoted/advertised to them to begin engagement and/or selection of the identifier 116 in the catalog. In some embodiments, historical data bin 600 may be stored in central database 132. A user operating a third-party remote device may receive, send, and interact with identifiers 116 through historical data bin 600.

Still referring to FIG. 6, server 104 is designed and configured to receive at least an identifier 116 of a promoted entity device 108, for example and with reference to FIGS. 1-5. Identifier 116 may include the first path 504 to the promoted entity device 108 and at least a set of instructions for at least a process to be performed on the promoted entity device 108. Server 104 may provide user interface that may be needed for a user to interact with devices on the streaming network system for selection of the at least an identifier 116. In some embodiments, selection of the at least an identifier 116 may be on a device operated by a third party, such as a third-party remote device. For a third-party remote device to access historical data bin 600, in some embodiments, wherein server 104 may be further configured to authenticate at least a content creator device 120 to provide access to the historical data bin utilizing an identification protocol. A “user identification protocol,” as used in this disclosure, is a protocol to confirm any element of data that identifies a remote device and/or a user thereof. User identification protocol may include without limitation using a MAC address, a serial number, a globally unique identifier 116 (GUID) a universally unique identifier 116 (UUID), a username, smart code 604, one or more user login credentials such as passwords, tokens and/or the like, and/or any other element suitable to identify a device and/or user thereof as described in this disclosure. The identification protocol may include verifying device fingerprint data. “Device fingerprint data,” as used in this disclosure, is data used to determine a probable identity of a device as a function of at least a field parameter a communication from the device. At least a field parameter may be any specific value set by a third-party remote device and/or user thereof for any field regulating exchange of data according to protocols for electronic communication. As a non-limiting example, at least a field may include a “settings” parameter such as SETTINGS_HEADER_TABLE_SIZE, SETTINGS_ENABLE_PUSH, SETTINGS_MAX_CONCURRENT_STREAMS, SETTINGS_INITIAL_WINDOW_SIZE, SETTINGS_MAX_FRAME_SIZE, SETTINGS_MAX_HEADER_LIST_SIZE, WINDOW_UPDATE, WINDOW_UPDATE, WINDOW_UPDATE, SETTINGS_INITIAL_WINDOW_SIZE, PRIORITY, and/or similar frames or fields in HTTP/2 or other versions of HTTP or other communication protocols. Additional fields that may be used may include browser settings such as “user-agent” header of browser, “accept-language” header, “session_age” representing a number of seconds from time of creation of session to time of a current transaction or communication, “session_id,” ‘transaction_id,” and the like. Determining the identity of a third-party remote device may include fingerprinting the third-party remote device as a function of at least a machine operation parameter, described a communication received from a third-party remote device. At least a machine operation parameter, as used in this disclosure, may include a parameter describing one or more metrics or parameters of performance for a device and/or incorporated or attached components; at least a machine operation parameter may include, without limitation, clock speed, monitor refresh rate, hardware or software versions of, for instance, components of a third-party remote device, a browser running on a third-party remote device, or the like, or any other parameters of machine control or action available in at least a communication. In an embodiment, a plurality of such values may be assembled to identify a third-party remote device and distinguish it from other devices.

Still referring to FIG. 6, server 104 is configured to provide the at least an identifier 116 in a historical data bin 600 to a content creator operating a content creator device 120, wherein historical data bin 600 includes at least a smart code 604 attached the at least identifier 116. A “smart code,” as used in this disclosure, is a code associated with an identifier 116 and the historical data of the identifier 116. The historical data may be the transaction history of the identifier 116, such the identity of the party to send the identifier 116, the identity of the party that selected/received the identifier 116, the number of parties engaged in the identifier 116, the contents of the identifier 116, and the like. Smart code 604 may be a hyperlink, URL or numerical sequence that may be clicked on or entered in historical data bin 600 to display a catalog containing all data linked to smart code 604. In some embodiments, smart code 604 may be linked between an operator of the promoted entity device 108 and a content creator operating a content creator device 120, and/or at least identifier 116. For example, a smart code 604 may link to the transaction history between to a promoted entity operating promoted entity device 108, promoted entity name, a service provided by promoted entity, a keyword or other textual datum for triggering a textual output during an audial or other continuous data stream, monetary compensation for a content creator allowing for the textual output to be associated with their continuous data stream, a path such as without limitation a URL to a location of the third-party device such as a promoted entity website, a set of rules for how an association during a continuous data stream, for instance as described below, may take place. Furthering the example, smart code 604 may also link to a content creator operating a content creator device 120, the selection of the identifier 116 made by the to a content creator, such as instructions or passing an argument and/or datum indicating acceptance; acceptance may indicate acceptance of rules and terms of an agreement for having a promoted entity textual output displayed during a continuous data stream provided by and/or from content creator and/or content creator device 120, and the like. In some embodiments, smart code 604 may be used to the track the status of the identifier 116. For example, the completion of a promotional agreement to be carried out by the streaming content provider, payment processing by the promoted entity, time of completion, holds on agreements, disputes, revocations, breaches, and the like. Additionally, server 104 is configured to receive from the content creator operating the content creator device 120, a selection of the at least an identifier 116 in the historical data bin, for example and with reference to FIGS. 1-5. In some embodiments, smart code 604 may be associated with a historical record within historical data bin 600. As used in this disclosure, a “historical record,” is a summarized description of at least an identifier. For example, identifier 116 may relate to a sponsorship agreement and the historical record may summarize and/or highlight the names of the parties to the agreement, main objectives, date of effectiveness and other critical aspects of identifier 116. A historical record may relate to identifier 116, historical data, identification of remote devices and any other form of data described throughout this disclosure.

Still referring to FIG. 6, server 104 is configured to generate a dual-path resource locator 128, wherein the dual-path resource locator 128 identifies, using smart code 604, a first path 504 to the promoted entity device 108 based on the selection of the at least an identifier 116 and a second path 508 to the content creator device 120 based on the selection. For example, dual-path resource locator 128 may use smart code 604 to navigate through central database 132 to identify both first path 504 and second path 508 based on the selection of the identifier 116. In some embodiments, generating the dual-path resource locator 128 further includes generating one or more uniform resource locators associated with the promoted entity device 108, for example and with reference to FIG. 1-5. Additionally, generating the dual-path resource locator 128 further includes storing the dual-path resource locator 128 in historical data bin 600 on the at least a server, such as server 104.

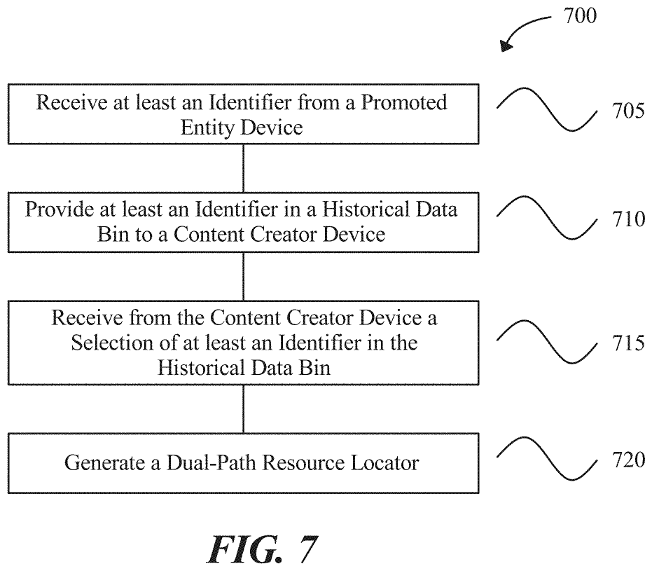

Referring now to FIG. 7, is exemplary flow diagram of a method 700 for identifier 116 exchange through a historical data bin. At step 705, method 700 includes receiving, by at least a server, at least an identifier 116 from a promoted entity device 108, for example and with reference to FIGS. 1-6. The identifier 116 may include the first path 504 to the promoted entity device 108 and at least a set of instructions for at least a process to be performed on the promoted entity device 108. At step 710, method 700 includes providing, by the least a server, the at least an identifier 116 in a historical data bin to content creator device 120, wherein the historical data bin includes at least a smart code attached the at least identifier 116, for example and with reference to FIGS. 1-6. The server may provide a graphical user interface 124 for selection of the at least an identifier 116 on content creator device 120. The historical data bin includes a historical record of the least identifier 116. In some embodiments, server 104 is further configured to authenticate at least content creator device 120 to provide access to the historical data bin 600 utilizing an identification protocol. The user identification protocol may include verifying device fingerprint data as described above. In some embodiments, the smart code may be linked between a promoted entity device 108, a content creator device 120, and at least identifier 116. In some embodiments, receiving a selection of the at least an identifier 116 may further include receiving second path 508 content creator device 120. At step 715, method 700 includes receiving, by the least a server, from s content creator device 120, a selection of the at least an identifier 116 in the historical data bin. At step 720, method 700 includes generating, by the least a server, a dual-path resource locator 128, wherein the dual-path resource locator 128 identifies using smart code 604, a first path 504 to the promoted entity device 108 based on the selection of the at least an identifier 116 and a second path 508 to content creator device 120 based on the selection, for example and with reference to FIGS. 1-6. In some embodiments, generating the dual-path resource locator 128 may further include generating one or more uniform resource locators associated with the promoted entity device 108. In some embodiments, generating the dual-path resource locator 128 may further include storing the dual-path resource locator 128 in historical data bin on the at least a server.

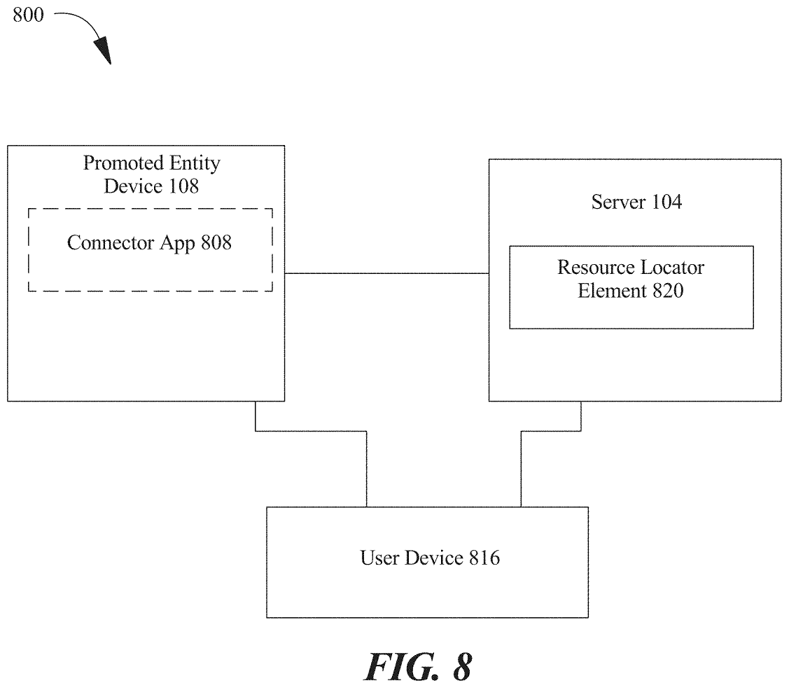

Now referring to FIG. 8, in the e-commerce industry, it is common for retailers to offer promotions and discounts to attract customers and increase sales. However, traditional methods of promotion, such as advertisements and email campaigns, can be costly and ineffective. Content creators, such as podcasters, influencers, and streaming content providers, have become popular sources for promoting performance marketing campaigns for e-commerce retailers due to their engaged audiences. However, e-commerce retailers mostly require an ad agency to connect them to content creators and manage the process. That is not cost-effective for the majority of online retailers. Nor is it for the content creators. There is a need for a simple, risk-free, cost-effective method of connecting online retailers with content creators; so content creators can promote products for sale by various e-commerce retailers. Furthermore, e-commerce retailers would not have to purchase advertising. Instead, they would pay a sales commission to the content creator when an audience member of the content creator makes a purchase.

Still referring to FIG. 8, described herein is a platform that solves these problems by providing a solution for e-commerce retailers to connect with content creators, who may promote the online retailer's products to their audiences. Moreover, it encourages those audiences to make purchases using the unique resource locator elements of the content creator. A platform may include a connector app, other program or module, server 104, and/or other computing device installed by an e-commerce retailer in their online store, a network of content creators who promote the retailer's products, a system for generating resource locator elements and registering them at the online merchant store, and a system for managing commissions and payments when the audience members of the content creator make purchases. A connector app, other program or module, server 104, and/or other computing device may synchronize with an online merchant and read information about the promotions, products, and discounts the online retailer will offer. A connector app, other program or module, server 104, and/or other computing device may enable seamless integration between online retailers and content creators. A platform may also provide a dashboard for a merchant to view performance statistics, allowing them to monitor sales generated for each promotion, the number of discount codes redeemed, and the commission paid for each sale. Alternatively or additionally, any function described in this disclosure as performed using connector app, other program or module, server 104, and/or other computing device may be performed by server 104 and/or any other computing device described in this disclosure; communication functions, exchange of data, or the like may be performed, without limitation, using an application programming interface as described in further detail below. Scraping, document object model exploration, and other analysis of promoted entity device 108, websites, applications, or the like may likewise be performed by server 104, any other computing device, and/or programs and/or modules operating thereon.

Still referring to FIG. 8, the technology described in this disclosure may solve problems inherent in network-based advertisement and communication by permitting a seamless integration of messages, network paths, and streaming media; the means and methods employed obviate the need for manual intervention in association of such communication with such media, permitting content creators a previously impossible degree of real-time content association. Embodiments may enable the process for the content creator and marketer to configure the behavior of resource locator elements, the benefits given to the consumer, and the terms between the content creator and marketer. Display of resource locator elements using various user interface methods may advantageously make it easier and intuitive for the consumer to interact with the resource locator element and participate in the offers, discounts, exclusive access, that the marketer is offering. Based on triggers created by the messages, resource locator elements may be displayed via various user interfaces a user would utilize to experience media; such displays may enable interactions such as redeeming a unique code agreed upon by a content creator and the marketer to enable a benefit to an activating user. Code triggers may include without limitation tagging, audio recognition, geolocation cues, push notifications, historical reference lists, and/or other triggering events as described above. In some embodiments, a resource locator element may include a smart code.

Still referring to FIG. 8, as a further non-limiting example, embodiments described in this disclosure may be incorporated in and enable an audio playback player with a visual user interface that is context-aware of the content it is playing; the audio player may track playback of specific audio encoded with metadata synced to timestamps of the audio—when playback hits the encoded timestamps the audio player user interface displays relevant associated information, such as resource locator elements, based on the timestamp metadata. A user may be able to click, touch, or use voice for immediate redemption at the advertiser's site. Alternatively, or additionally, a user based on geolocation may have a resource locator element automatically displayed in their device to show at a retail location. As an additional non-limiting example, an interface may keep a catalog (or historical data bin) of all resource locator elements available for the user, allowing a user to reference any opportunity the user would like to take advantage of at their leisure. Encoding of the metadata to timestamps of the audio file may happen manually in a database or automatically via audio recognition technology which “listens” for key phrases associated with the metadata; for instance, in methods as described above, detection of a data element in a continuous data stream may be coupled with clock-based measurements to create a timestamp indicating a time within streaming content for display of, for instance a display fragment as described above. Methods for presenting resource locator elements for a user to interact with as described above may make the process of offer redemption dramatically more intuitive, ultimately driving higher sales for marketers, and opening new revenue generation capability for all content creators.

Still referring to FIG. 8, an exemplary embodiment of a system 800 for connector application functionality is illustrated. System 800 may include and/or operate on one or more computing devices, including one or more server devices and/or one or more user devices 816. For instance, an application such as a “connector app” 808 as described in this disclosure may include an application that operates on a user device 816, a server, or any other computing device as described in this disclosure. As a further non-limiting example, a “virtual marketplace” may include a web application and/or other application that operates on a server or other computing device; this application may communicate with, transmit data to, and/or receive data from an application such as connector app, other program or module, server 104, and/or other computing device, a web browser, and/or any other system and/or module operating on a user device 816. Such applications, virtual marketplaces, and/or other software and/or hardware modules as disclosed in this disclosure may be implemented, without limitation, in any manner that would occur to a person skilled in the art upon reading the entirety of this disclosure. A resource locator element 820 may be stored at, and/or utilized by, promoted entity device 108, server 104, and/or a virtual marketplace.

Still referring to FIG. 8, system 800 may include a computing device. A computing device may include any computing device as described in this disclosure, including without limitation a microcontroller, microprocessor, digital signal processor (DSP) and/or system on a chip (SoC) as described in this disclosure. computing device may include, be included in, and/or communicate with a mobile device such as a mobile telephone or smartphone. computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described above with reference to server 104. In some embodiments, system 800 may include server 104.

Still referring to FIG. 8, system 800 may include a connector app, which may be installed in and/or interact with a promoted entity device to identify products on sale. Connector app may operate, without limitation, on user device 816 as a widget or plug-in at a website and/or web browser, or the like. Connector app, other program or module, server 104, and/or other computing device may, without limitation; browse a document object model, file directory, or the like of promoted entity device and/or a website and/or other data structure stored thereon and/or associated therewith, and may identify objects for sale using language processing, machine-learning classification, string comparison to stored terms describing items for sale, and/or by reference to information provided by promoted entities. Connector app, other program or module, server 104, and/or other computing device may be configured to generate a resource locator element such as without limitation a unique promotional code for a content creator to promote such products for sale; promotional code may be implemented, without limitation, as a resource locator, code; or other data object as described in this disclosure. Generation of resource locator element may include, without limitation, selection and/or entry thereof by content creator, a content creator device 120, and/or any other person or device. For instance, and without limitation, a content creator and/or a person and/or device associated therewith and/or operated thereby may choose a promotional code to be associated with such content creator and/or a person and/or device. Alternatively or additionally, generation of resource locator element may be performed automatically using one or more processes described in this disclosure. Promoted entity device 108, server 104, and/or any other device may determine whether resource locator element is unique by, for instance, comparing resource locator element to other such elements being used and/or stored at promoted entity device 108, server 104, and/or any other network location and/or device; uniqueness, as used in this context, may indicate that a resource locator element is unique as compared to similar resource locator elements within a given context, including uniqueness at promoted entity device 108, uniqueness among all similar resource locator elements used by entities operating and/or affiliated with promoted entity device 108, uniqueness among similar resource locator elements as stored on and/or operated by server 104 and/or an online marketplace, or the like. In some embodiments, promoted entity device 108, server 104, and/or any other device may determine that resource locator element is identical to a resource locator element of a similar type that is already in use; for instance, where resource locator element is a promotional code, a promotional code that is the same and/or similar may already be in use. Such detection may include detection of homonyms or near-homonyms of a proposed resource locator element such as a promotional code, where detection of homonyms or near-homonyms may be determined using a machine-learning model, classifier, and/or language processing model; for instance, and without limitation, such a model may be trained using a corpus and/or training data containing words associated with pronunciations, where similar sounding words are mapped to vectors in a vector space where similar-sounding words' vectors are closer to each other and/or have a smaller angle therebetween that vectors for words that do not sound similar to one another. Alternatively or additionally, training examples may be labeled by users as similar or dissimilar and used to train a classifier, clustering algorithm, or the like such as K-nearest neighbors, k-means clustering, particle swarm optimization or similar to associate words and phrases according to similar sounds. Such a model may input two words and/or phrases and output, without limitation, an indication that they are similar above a given threshold measure of similarity, that they belong to a cluster of highly similar sounds according to a distance metric used in any of the above-described algorithms, or the like. Upon detection that the same or similar resource locator element and/or promotional code is already in use, device and/or process performing such detection may initiate generation of a different resource locator element and/or promotional code by, for instance, initiating automatic generation thereof and/or prompting a content creator or other user to enter another potential resource locator element and/or promotional code.

Connector app, other program or module, server 104, and/or other computing device may be configured to register the resource locator element in the promoted entity device. Registration may be accomplished, without limitation, by transmitting the resource locator element to a device operating the retail store; alternatively or additionally, registration may include generating a user interface element that displays at a user device in conjunction with, as a layer on top of, or the like a view of the promoted entity device. Such user interface element, which may be implemented using frames, layers, or other user interface objects loading a user-interface component of promoted entity device (e.g. by loading a web page thereof in a frame or layer in a web page, native app, or the like that is, operates on, and/or interacts with connector app, other program or module, server 104, and/or other computing device); Such user interface element may detect section and/or purchase of objects for sale by intercepting and/or modifying event handlers on user-interface component of promoted entity device. This may alternatively or additionally be performed by modifying source code of promoted entity device, being installed thereon or therewith as a plug-in and/or client-side program, or the like.

Still referring to FIG. 8, connector app, other program or module, server 104, and/or other computing device may, in a non-limiting example, be configured to read one or more of the following attributes from the promoted entity device to enable syncing with content creators: (1) dates a promotion associated with the resource locator element will be offered; (2) the discount the consumer will receive; (3) a type of discount associated with the resource locator element, such as without limitation % off an entire cart purchase or specific product; (4) the product name and category. Connector app, other program or module, server 104, and/or other computing device may be configured to check if the content creator's preferred resource locator element is already in use, or in other words whether another user and/or usage has been associated therewith on the

Still referring to FIG. 8, connector app, other program or module, server 104, and/or other computing device may be configured to notify a virtual marketplace of a sale made using the resource locator element; sale using resource locator element may be detected, without limitation, by detection of a user entry of resource locator element and/or by tracking navigation to a site where sale is performed from a promotional link or other resource locator.

Still referring to FIG. 8, a system may include a virtual marketplace where content creators and e-commerce retailers can connect; virtual marketplace may operate, without limitation, on a device separate from a device and/or server operating promoted entity device. Virtual marketplace may be configured to generate a unique resource locator element for each content creator to promote a promoted entity device's products. In some embodiments, a virtual marketplace and a system for identifier exchange may be integrated. In a non-limiting example, a dual path resource locator may be determined as a function of a datum input by a promoted entity device associated user into a virtual marketplace. In another non-limiting example, a resource locator element exchanged using a virtual marketplace may be displayed on a stream as a function of a data element detected from a continuous data stream containing audio content.

With continued reference to FIG. 8, server 104, connector app, promoted entity device 108 or other computing devices, modules, and/or programs described in this disclosure may be configured to detect entry of a resource locator element and/or promotional code into a sales program and/or shopping cart at promoted entity device 108. Such detection may be performed, without limitation, by communication from promoted entity device 108 to other device, module, and/or program, of such entry, for instance and without limitation using an API or other communication channel. Alternatively or additionally, a connector app, widget, and/or plug-in may detect entry of resource locator element and/or promotional code at sales program and/or shopping cart, and/or a web crawler, scraper, or the like may perform such detection.

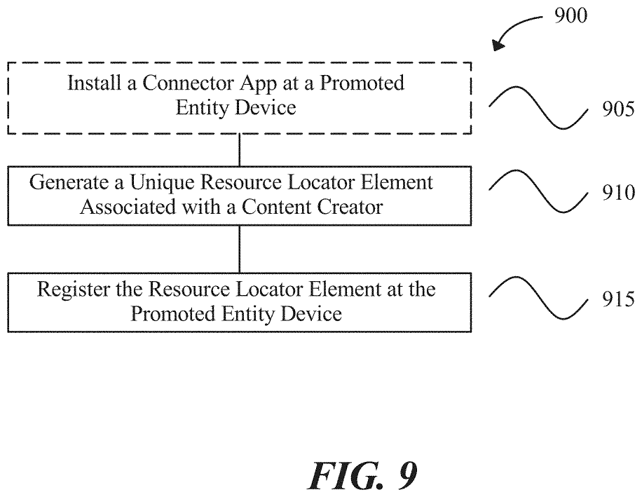

Now referring to FIG. 9, an exemplary embodiment of a method 900 of connector application functionality is disclosed. At optional step 905, one or more computer devices as described above may install a connector app in the promoted entity device to identify products on sale; this may be implemented, without limitation, in any manner described in this disclosure. At step 905, one or more computer devices as described above may connect to the virtual marketplace to advertise the products; this may be implemented, without limitation, in any manner described in this disclosure. At step 910, one or more computer devices as described above may generate a unique resource locator element for a content creator to promote the products; this may be implemented, without limitation, in any manner described in this disclosure. At step 915, one or more computer devices as described above may register a resource locator element at a promoted entity device; this maybe done via a connector app, other program or module, server 104, and/or other computing device; this may be implemented, without limitation, in any manner described in this disclosure. In some exemplary embodiments one or more computer devices as described above may notify promoted entity device 108 and/or virtual marketplace of a sale made using the resource locator element; this may be implemented, without limitation, in any manner described in this disclosure. In some exemplary embodiments, one or more computer devices as described above may charge the promoted entity device for the commission due to the content creator for promotion of the product and enabling the sale; this may be implemented, without limitation, in any manner described in this disclosure.

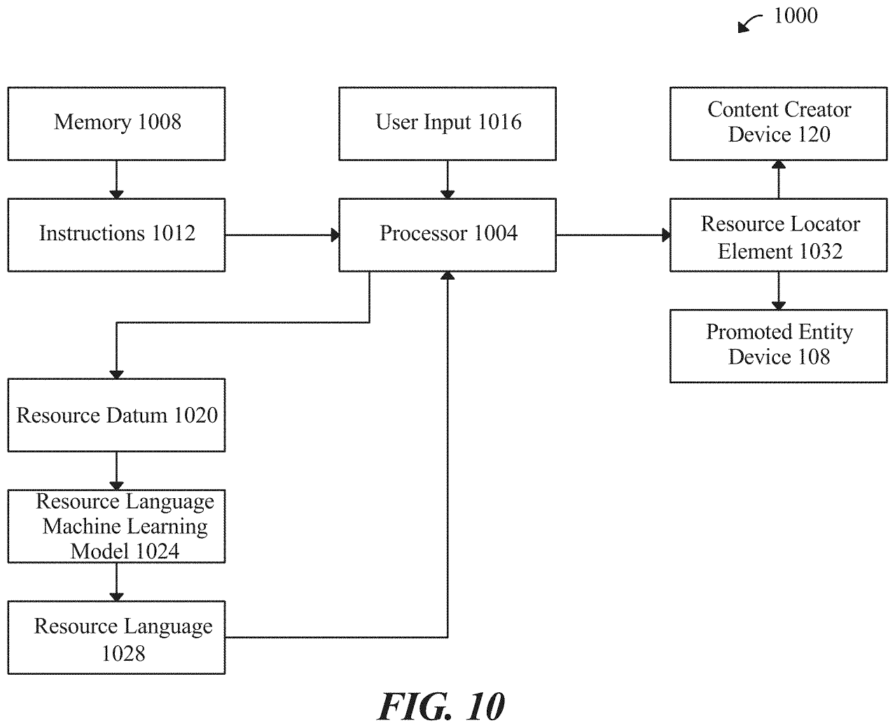

Now referring to FIG. 10, described herein is a method of generating promotional material. In some circumstances, content creators and marketing teams may develop talking points and/or ad copy for content creators to read, display, and/or otherwise promote. However, writing such talking points and/or ad copy may be a time-consuming process. As described further below, connector app, other program or module, server 104, and/or other computing device and/or associated systems may solve this problem by generating ad copy and talking points.

Still referring to FIG. 10, in some embodiments, system 1000 may include at least a processor 1004 and a memory 1008 communicatively connected to the at least a processor 1004, the memory 1008 containing instructions 1012 configuring the at least a processor 1004 to perform one or more processes described in this disclosure. Computing devices including memory 1008 and at least a processor 1004 are described in further detail in this disclosure.

Still referring to FIG. 10, in some embodiments, system 1000 may receive user input 1016. In some embodiments, system 1000 may include at least a processor 1004 and memory 1008 communicatively connected to the at least processor 1004, the memory 1008 containing instructions 1012 configuring the at least processor 1004 to receive user input 1016.

Still referring to FIG. 10, user input 1016 may include a datum identifying a user, profile, channel, or the like. In some embodiments, user input 1016 may include at least an identifier 106. In some embodiments, user input 1016 may include identifying information associated with a content creator and/or content creator device 120, identifying information associated with a promoted entity and/or promoted entity device 108, and a datum indicating a desire to receive resource locator element. In a non-limiting example, a promoted entity device 108 may transmit to system 1000 user input 1016 indicating a desire to receive resource locator element relevant to a particular content creator profile. A content creator profile may include, in a non-limiting example, a social media profile. In some embodiments, user input 1016 may include a URL of a content creator profile.

Still referring to FIG. 10, user input 1016 may be received from content creator device 120. User input 1016 may be received from promoted entity device 108. A promoted entity device 108 and/or content creator device 120 may include, in non-limiting examples, a computer, tablet, or smartphone. In some embodiments, user input 1016 may be input through an interface. An interface may include a graphical user interface (GUI). An interface may include a touch-screen GUI interface. An interface may include a computing device configured to receive an input from a user. In some embodiments. an interface may be configured to prompt a user for an input. In a non-limiting example, an interface may request that a user input a URL of a content creator profile.

Still referring to FIG. 10, in some embodiments, system 1000 may generate a resource datum 1020; such generation may be performed as a function of user input 1016 and/or prior to and/or independently of user input. Resource datum may relate information concerning content creator; alternatively or additionally, resource datum may relate solely to promoted entity, promoted entity device, and/or a product and/or service associated therewith. In some embodiments, system 1000 may include at least a processor 1004 and memory 1008 communicatively connected to the at least processor 1004, the memory 1008 containing instructions 1012 configuring the at least processor 1004 to generate a resource datum 1020 as a function of user input 1016.

Still referring to FIG. 10, as used in this disclosure, a “resource datum” is an element of data to use as and/or incorporated in a resource locator element. Resource datum may include a script datum. As used in this disclosure, a “script datum” is a datum or data associated with a product, service, entity, or site to be promoted. As non-limiting examples, script datum may include the name of a site to be promoted, related brand names, products sold by the site, slogans used by the site, services offered on the site, demographic information associated with customers and the like. In some embodiments, script datum may further include data describing a content creator, a content creator profile, a content creator's content and/or a content creator's audience. As non-limiting examples, script datum may include the name of a content creator, a profile associated with a content creator, phrases commonly said by a content creator, subject matter commonly brought up in content produced by content creator, other content creators associated with a content creator, demographic information associated with a content creator's audience, tags associated with a content creator and/or their content, transcripts of audio or audio and video content produced by content creator, and the like.

Still referring to FIG. 10, in some embodiments, resource datum 1020 may be received from a third party. In a non-limiting example, a third party may operate a database including resource datum 1020, processor 1004 may request resource datum 1020 from the database using an application programming interface (API), and processor 1004 may receive from the database, or a computing device associated with the database, resource datum 1020.

Still referring to FIG. 10, resource datum 1020 may be input through an interface. Resource datum 1020 may be input through an interface used to collect user input. In a non-limiting example, an interface may include a first field allowing a user to input a URL associated with site, product, or service to be promoted, and a second field allowing a user to additional relevant information such as keywords. In this example, an interface may include a third field allowing a user to input a URL associated with a content creator profile. Alternatively or additionally, such data elements may be automatically retrieved, communicated, scraped, or the like using any app, program, module and/or computing device described in this disclosure.

Still referring to FIG. 10, in some embodiments, a resource datum source may include a web crawler or may store resource datum 1020 obtained using a web crawler. A web crawler may be configured to automatically search and collect information related to a site, product, or service to be promoted. As used in this disclosure, a “web crawler” is a program that systematically browses the internet for the purpose of web indexing. The web crawler may be seeded with platform URLs, wherein the crawler may then visit the next related URL, retrieve the content, index the content, and/or measures the relevance of the content to the topic of interest. In one embodiment, the web crawler may be configured to scrape resource datum 1020 from promotion target related social media and networking platforms. The web crawler may be trained with information received from a user through a user interface. As a non-limiting example, an employee of a company wishing to be promoted may input into a user interface, social media platforms the company has accounts on and would like to retrieve data from. A user interface may include a graphical user interface (GUI), command line interface (CLI), menu-driven user interface, touch user interface, voice user interface (VUI), form-based user interface, and the like. Processor may receive resource datum 1020 including information such as brand names, slogans, offered products, offered services, and the like. In a situation where content creator related info is received, such information may include, in non-limiting examples, a content creator's name, user's profile, platform handles, platforms associated with the user, videos produced by content creator, audio files produced by content creator, comments made by content creator, content liked by content creator, and the like. In some embodiments, a web crawler may be configured to generate a web query. A web query may include search criteria. Search criteria may include account handles, web page addresses and the like received from a user. A web crawler function may be configured to search for and/or detect one or more data patterns. A “data pattern” as used in this disclosure is any repeating forms of information. A data pattern may include, but is not limited to, features, phrases, and the like as described further below in this disclosure.

Still referring to FIG. 10, in some embodiments, a web crawler may work in tandem with a program designed to interpret information retrieved using a web crawler. As a non-limiting example, a machine learning model may be used to generate a new query as a function of prior search results. As another non-limiting example, data may be processed into another form, such as by using optical character recognition to interpret images of text. In some embodiments, a web crawler may be configured to determine the relevancy of a data pattern. Relevancy may be determined by a relevancy score. A relevancy score may be automatically generated by processor 1004, received from a machine learning model, and/or received from a user. In some embodiments, a relevancy score may include a range of numerical values that may correspond to a relevancy strength of data received from a web crawler function. As a non-limiting example, a web crawler function may search the Internet for data related to content produced by or associated with content creator. In some embodiments, computing device may determine a relevancy score of resource datum 1020 retrieved by a web crawler.

Still referring to FIG. 10, in some embodiments, system 1000 may generate resource language 1028 as a function of resource datum 1020 using a resource language machine learning model 1024. In some embodiments, system 1000 may include at least a processor 1004 and memory 1008 communicatively connected to the at least processor 1004, the memory 1008 containing instructions 1012 configuring the at least processor 1004 to generate resource language 1028 as a function of resource datum 1020 using a resource language machine learning model 1024.

Still referring to FIG. 10, as used in this disclosure, “resource language” is a series of characters, words, or both that may be, be included in, and/or may include a resource locator element; resource language may include, without limitation, script language. As used in this disclosure, “script language” is a series of characters, words, or both that may be used to promote a product, service, entity, or site. In some embodiments, resource language may be in a natural language format. As used in this disclosure, a “natural language format” is a format for communicating information corresponding to a style of speaking, writing, signing or otherwise using a language that naturally occurs or might naturally occur between a plurality of humans communicating in that language. For example, a natural language format may simulate a format that a content creator would utilize when speaking with another person such as a friend or a member of content creator's audience. In some embodiments, system 1000 may utilize machine learning to generate resource language. In some embodiments, system 1000 may utilize a resource language machine learning model 1024 to generate resource language. In some embodiments, resource language machine learning model 1024 may include a language model such as a language processing engine to generate resource language. As used in this disclosure, a “language model” is a program capable of interpreting natural language, generating natural language, or both. Language models such as language processing engines are described in further detail herein, such as with respect to FIG. 4.

Still referring to FIG. 10, in some embodiments, resource language machine learning model 1024 may be trained using supervised learning. Resource language machine learning model 1024 may be trained on a data set including historical script data such as historical versions of web pages, businesses, products, and the like, and scripts of promotions of those web pages. Such a data set may be produced by, for example, receiving relevant data from major advertisers or media platforms. Alternatively, or additionally, such a data set may be produced by using a speech to text function to transcribe promotions, and manually associating those promotions with the product, service, site, or the like being promoted. Resource language machine learning model 1024 may accept script data as an input and may output resource language.

Still referring to FIG. 10, in some embodiments, resource language machine learning model 1024 may be trained on a dataset including transcripts of content produced by content creators, associated with historical resource language. For example, a data set may be created by finding promotions by content creators and using transcripts of content posted before a promotion as the associated historical script data; such transcripts may be produced using a speech recognition module and/or a language model. In this example, a set of transcripts of content creator videos associated with a transcript of a promotion may make up a single training example in a larger set of training data. In some embodiments, resource language machine learning model 1024 may be trained on a dataset including both transcripts of content produced by content creators, and promoted content, associated with promotion transcripts; in this version of resource language machine learning model 1024, transcripts of content produced by content creators, and promoted content may be categorized differently both in the training data set and as inputs into the machine learning model. Such training examples may correlate content with associated products, associated services, and/or content creators; such training examples may be labeled by one or more users as more or less effective in promoting products, services, and/or entities, such that such language may be interpreted by system as more or less effective in such promotion and thus generated as an output from resource language machine-learning model upon input of product, service, and/or entity information, which may be input with or without content creator information.

Still referring to FIG. 10, in some embodiments, resource language machine learning model 1024 may be trained using reinforcement learning. For example, resource language machine learning model 1024 may be trained by providing it with an input, receiving an output, and scoring the output. In a reinforcement learning algorithm, resource language machine learning model 1024 may adjust its outputs to optimize for high scoring outputs. In some embodiments, resource language machine learning model 1024 may be trained using multiple training stages. In a non-limiting example, resource language machine learning model 1024 may be trained first using supervised learning then using reinforcement learning.

Still referring to FIG. 10, in some embodiments, script data may be processed using automatic speech recognition. In some embodiments, automatic speech recognition may require training (i.e., enrollment). In some cases, training an automatic speech recognition model may require an individual speaker to read text or isolated vocabulary. In some cases, speech training data may include an audio component having an audible verbal content, the contents of which are known a priori by a computing device. Computing device may then train an automatic speech recognition model according to training data which includes audible verbal content correlated to known content. In this way, computing device may analyze a person's specific voice and train an automatic speech recognition model to the person's speech, resulting in increased accuracy. Alternatively, or additionally, in some cases, computing device may include an automatic speech recognition model that is speaker independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 10, in some embodiments, an automatic speech recognition process may perform voice recognition or speaker identification. As used in this disclosure, “voice recognition” refers to identifying a speaker, from audio content, rather than what the speaker is saying. In some cases, computing device may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within script data, but others may speak as well.

Still referring to FIG. 10, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 10, an exemplary algorithm employed in automatic speech recognition may include or even be based upon hidden Markov models. Hidden Markov models (HMIs) may include statistical models that output a sequence of symbols or quantities. HMIs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 10, in some embodiments HMIs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 10, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 10, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 10, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighted by their estimated probability. In some cases, an employed loss function may include Levenshtein distance, although different distance calculations may be performed, for instance for specific tasks. In some cases, a set of candidates may be pruned to maintain tractability.

Still referring to FIG. 10, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow computing device to find an optimal match between two given sequences (e.g., time series) with certain restrictions. That is, in some cases, sequences can be “warped” non-linearly to match each other. In some cases, a DTW-based sequence alignment method may be used in context of hidden Markov models.

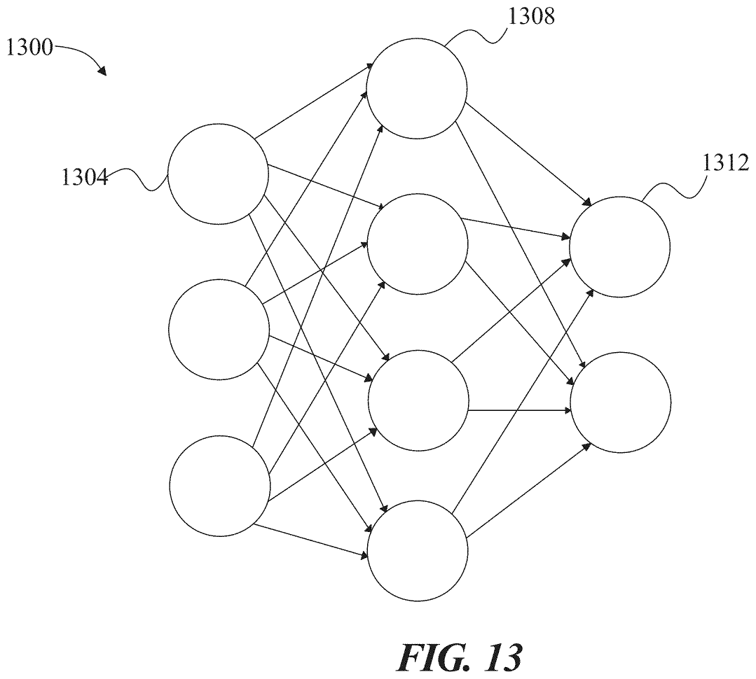

Still referring to FIG. 10, in some embodiments, an automatic speech recognition process may include a neural network. Neural network may include any neural network, for example those disclosed with reference to FIGS. 13-15. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time intervals, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

Still referring to FIG. 10, in some embodiments, system 1000 may generate resource locator element 1032 as a function of resource language 1028. In some embodiments, system 1000 may include at least a processor 1004 and memory 1008 communicatively connected to the at least processor 1004, the memory 1008 containing instructions 1012 configuring the at least processor 1004 to generate resource locator element 1032 as a function of resource language 1028.

Still referring to FIG. 10, resource locator element may include an electronic file, datum, and/or outer resource locator element including resource language. In some embodiments, processor 1004 may organize resource language into an easily accessible document format such as word, PDF, or a text file.

Still referring to FIG. 10, in some embodiments, system 1000 may transmit resource locator element 1032 to a user device. In some embodiments, system 1000 may include at least a processor 1004 and memory 1008 communicatively connected to the at least processor 1004, the memory 1008 containing instructions 1012 configuring the at least processor 1004 to transmit resource locator element 1032 to a user device. In some embodiments, system 1000 may transmit resource locator element 1032 to content creator device 120. In some embodiments, system 1000 may transmit resource locator element 1032 to promoted entity device 108.

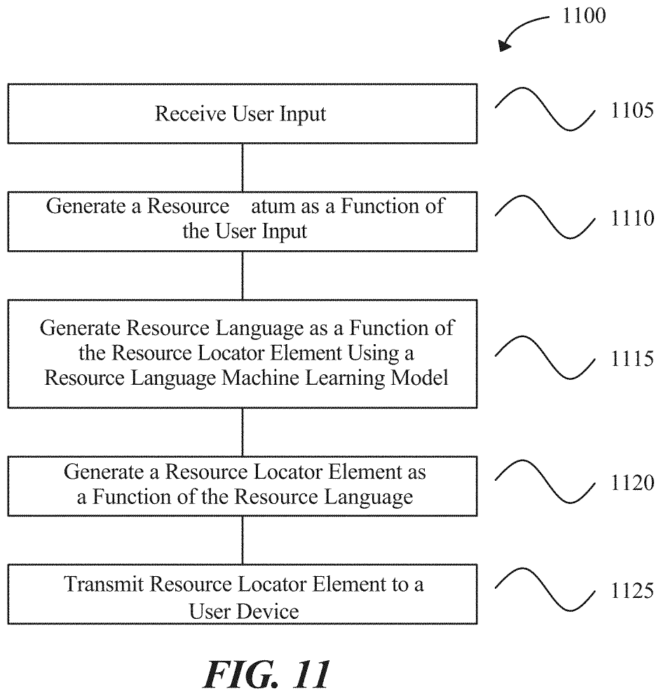

Now referring to FIG. 11, an exemplary embodiment of method 1100 of resource locator element generation is illustrated. In some embodiments, method 1100 may include receiving user input. In some embodiments, user input includes at least an identifier and originates from a promoted entity device. In some embodiments, method 1100 may include generating a resource datum as a function of the user input. In some embodiments, method 1100 may include generating resource language as a function of the resource datum using a resource language machine learning model. In some embodiments, method 1100 may include generating resource locator element as a function of the resource language. In some embodiments, method 1100 may include transmitting the resource locator element to a user device.

Still referring to FIG. 11, in some embodiments, method 1100 may further include transmitting the resource locator element to a user device associated with the content creator identifying datum. In some embodiments, method 1100 may further include generating a resource datum by making an API request to an API associated with the user input and receiving a resource datum. In some embodiments, method 1100 may further include generating a resource datum by navigating to a web page associated with the user input and generating a resource datum as a function of the web page. In some embodiments, method 1100 may further include collecting content creator data, and generating resource language as a function of the resource datum and the content creator data using a content creator data machine learning model. In some embodiments, method 1100 may further include generating a resource locator element and generating resource locator element as a function of the resource locator element. In some embodiments, method 1100 may further include transmitting the resource locator element to a content creator device. In some embodiments, method 1100 may further include providing the at least an identifier in a historical data bin to a content creator device operated by a steaming content provider, wherein the historical data bin includes at least a smart code attached to the at least identifier, receiving, from the content creator device, a selection of the at least an identifier in the historical data bin, and generating a dual-path resource locator, wherein the dual-path resource locator identifies, using the smart code, a first path to the promoted entity device based on the selection of the at least an identifier and a second path to the content creator device based on the selection. In some embodiments, method 1100 may further include receiving a continuous data stream from a content creator device, detecting at least a data element in the continuous data stream, and associating the dual-path resource locator with the continuous data stream as a function of the at least a data element.

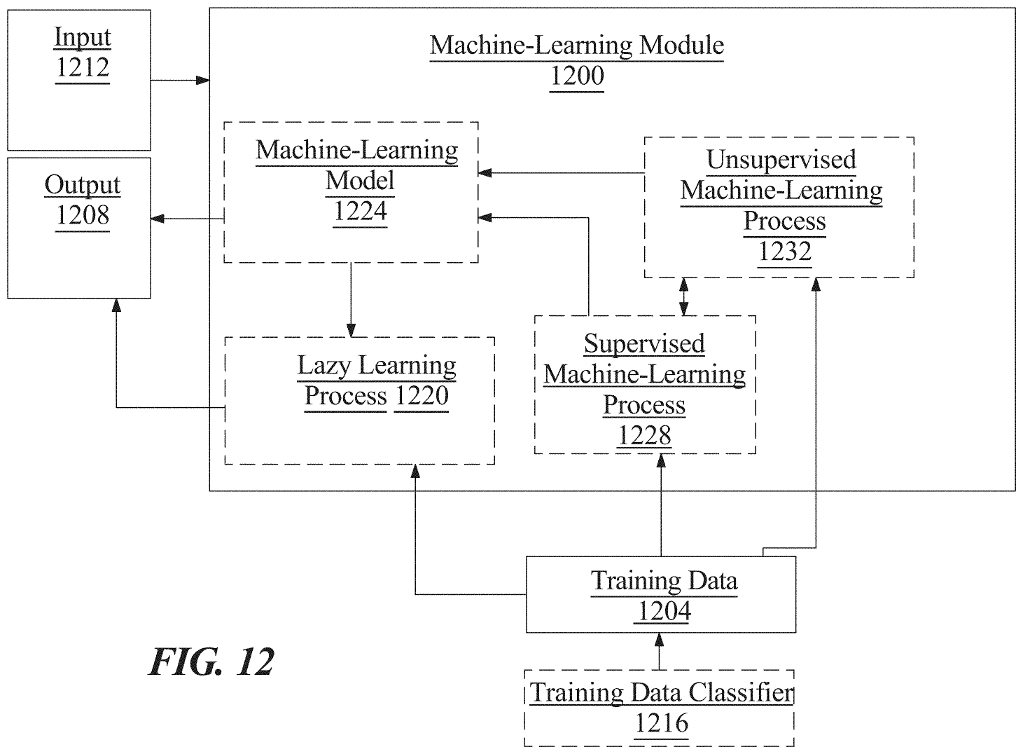

Referring now to FIG. 12, an exemplary embodiment of a machine-learning module 1200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1204 to generate an algorithm that will be performed by a computing device/module to produce outputs 1208 given data provided as inputs 1212; this is in contrast to a non-machine learning software program where the commands to be executed are determined in advance by a user and written in a programming language.

Still referring to FIG. 12, “training data,” as used in this disclosure, is data containing correlations that a machine-learning process may use to model relationships between two or more categories of data elements. For instance, and without limitation, training data 1204 may include a plurality of data entries, each entry representing a set of data elements that were recorded, received, and/or generated together; data elements may be correlated by shared existence in a given data entry, by proximity in a given data entry, or the like. Multiple data entries in training data 1204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1204 according to various correlations; correlations may indicate causative and/or predictive links between categories of data elements, which may be modeled as relationships such as mathematical relationships by machine-learning processes as described in further detail below. Training data 1204 may be formatted and/or organized by categories of data elements, for instance by associating data elements with one or more descriptors corresponding to categories of data elements. As a non-limiting example, training data 1204 may include data entered in standardized forms by persons or processes, such that entry of a given data element in a given field in a form may be mapped to one or more descriptors of categories. Elements in training data 1204 may be linked to descriptors of categories by tags, tokens, or other data elements; for instance, and without limitation, training data 1204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 12, training data 1204 may include one or more elements that are not categorized; that is, training data 1204 may not be formatted or contain descriptors for some elements of data. Machine-learning algorithms and/or other processes may sort training data 1204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1204 to be made applicable for two or more distinct machine-learning algorithms as described in further detail below. Training data 1204 used by machine-learning module 1200 may correlate any input data as described in this disclosure to any output data as described in this disclosure. As a non-limiting illustrative example, training data may correlate historical script data (such as text collected from web pages on promoted products) with historical transcripts of promotions of those products.

Further referring to FIG. 12, training data may be filtered, sorted, and/or selected using one or more supervised and/or unsupervised machine-learning processes and/or models as described in further detail below; such models may include without limitation a training data classifier 1216. Training data classifier 1216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1200 may generate a classifier using a classification algorithm, defined as a processes whereby a computing device and/or any module and/or component operating thereon derives a classifier from training data 1204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 12, machine-learning module 1200 may be configured to perform a lazy-learning process 1220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1204. Heuristic may include selecting some number of highest-ranking associations and/or training data 1204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 12, machine-learning processes as described in this disclosure may be used to generate machine-learning models 1224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 1224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1224 may be generated by creating an artificial neural network, such as a convolutional neural network comprising an input layer of nodes, one or more intermediate layers, and an output layer of nodes. Connections between nodes may be created via the process of “training” the network, in which elements from a training data 1204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 12, machine-learning algorithms may include at least a supervised machine-learning process 1228. At least a supervised machine-learning process 1228, as defined in this disclosure, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include script data as described above as inputs, resource language as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1204. Persons skilled in the art, upon reviewing the entirety of this disclosure, will be aware of various possible variations of at least a supervised machine-learning process 1228 that may be used to determine relation between inputs and outputs. Supervised machine-learning processes may include classification algorithms as defined above.

Further referring to FIG. 12, machine learning processes may include at least an unsupervised machine-learning processes 1232. An unsupervised machine-learning process, as used in this disclosure, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 12, machine-learning module 1200 may be designed and configured to create a machine-learning model 1224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 12, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Referring now to FIG. 13, an exemplary embodiment of neural network 1300 is illustrated. A neural network 1300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1304, one or more intermediate layers 1308, and an output layer of nodes 1312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

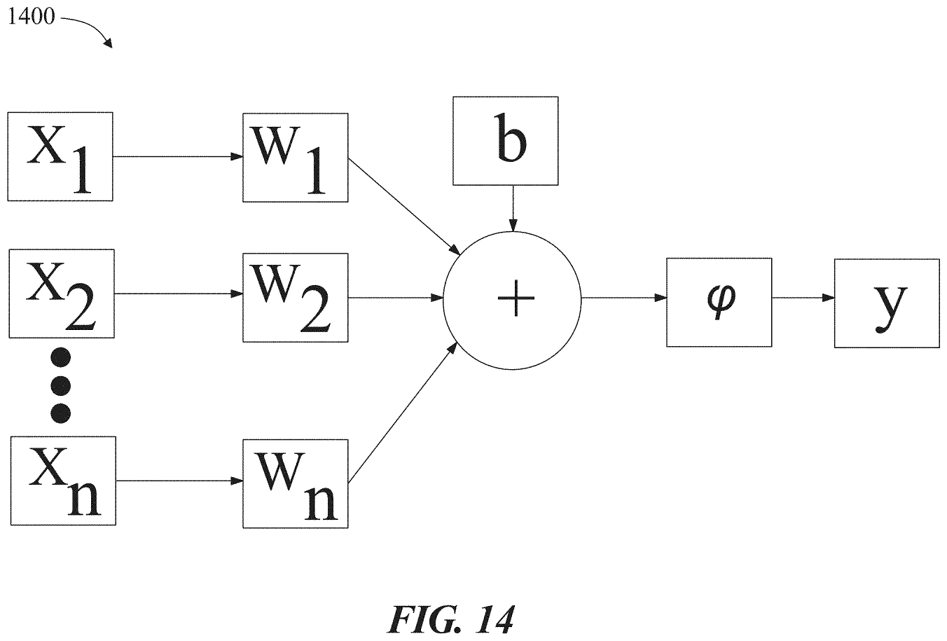

Referring now to FIG. 14, an exemplary embodiment of a node 1400 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max (0, x), a “leaky” and/or “parametric” rectified linear unit function such as ƒ(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as ƒ(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

It is to be noted that any one or more of the aspects and embodiments described in this disclosure may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding may readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

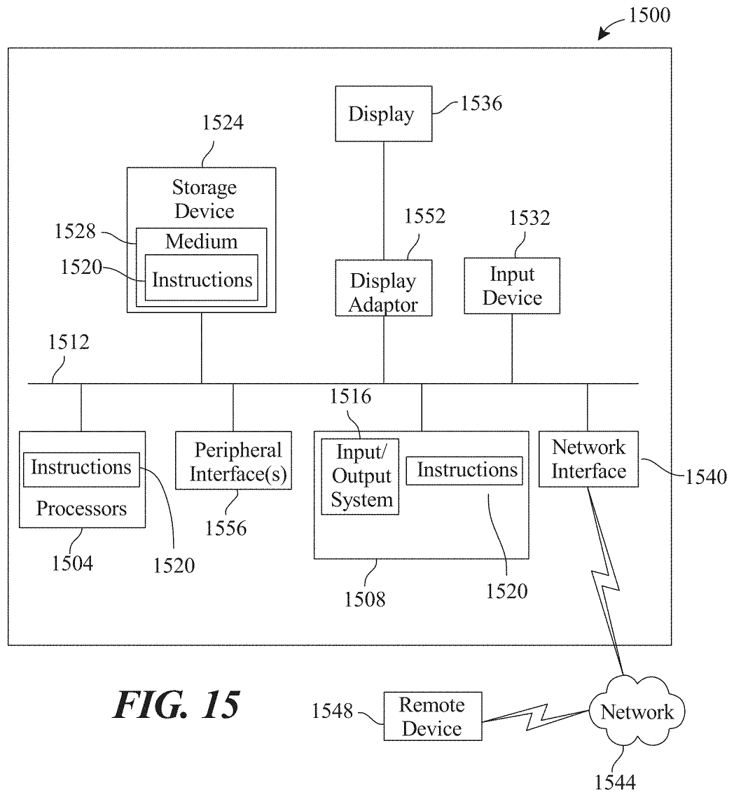

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions may be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. A system for resource locator element generation, the system comprising:
at least a processor; and
a memory communicatively connected to the at least processor, the memory containing instructions configuring the at least processor to:
receive user input;
generate a resource datum associated with the user input;
generate resource language as a function of the resource datum;
generate resource locator element as a function of the resource language; and
transmit the resource locator element to a promoted entity device.

2. The system of claim 1, wherein the user input comprises a content creator identifying datum, wherein the memory contains instructions configuring the at least processor to:
transmit the resource locator element to a content creator device associated with the content creator identifying datum.

3. The system of claim 1, wherein the memory contains instructions configuring the at least processor to:
generate a resource datum by making an application programming interface request to an application programming interface associated with the user input and receiving a resource datum.

4. The system of claim 1, wherein the memory contains instructions configuring the at least processor to:
generate a resource datum by navigating to a web page associated with the user input and generating a resource datum as a function of the web page.

5. The system of claim 1, wherein the memory contains instructions configuring the at least processor to:
collect content creator data; and
generate resource language as a function of the resource datum and the content creator data using a content creator data machine learning model.

6. The system of claim 1, wherein the memory contains instructions configuring the at least processor to:
generate a resource locator element; and
generate resource locator element as a function of the resource locator element.

7. The system of claim 1, wherein the memory contains instructions configuring the at least processor to:
transmit the resource locator element to a content creator device.

8. The system of claim 1, wherein the user input includes at least an identifier and originates from a promoted entity device.

9. The system of claim 8, wherein the memory contains instructions configuring the at least processor to:
provide the at least an identifier in a historical data bin to a content creator device operated by a steaming content provider, wherein the historical data bin includes at least a smart code attached to the at least identifier;
receive, from the content creator device, a selection of the at least an identifier in the historical data bin; and
generate a dual-path resource locator, wherein the dual-path resource locator identifies, using the smart code, a first path to the promoted entity device based on the selection of the at least an identifier and a second path to the content creator device based on the selection.

10. The system of claim 9, wherein the memory contains instructions configuring the at least processor to:
receive a continuous data stream from a content creator device;
detect at least a data element in the continuous data stream; and
associate the dual-path resource locator with the continuous data stream as a function of the at least a data element.

11. A method for resource locator element generation, the method comprising:
using at least a processor, receiving user input;
using at least a processor, generating a resource datum associated with the user input;
using at least a processor, generating resource language as a function of the resource datum;
using at least a processor, generating resource locator element as a function of the resource language; and
using at least a processor, transmitting the resource locator element to a promoted entity device.

12. The method of claim 1, further comprising:
using at least a processor, transmitting the resource locator element to a content creator device associated with the content creator identifying datum.

13. The method of claim 1, further comprising:
using at least a processor, generating a resource datum by making an application programming interface request to an application programming interface associated with the user input and receiving a resource datum.

14. The method of claim 1, further comprising:
using at least a processor, generating a resource datum by navigating to a web page associated with the user input and generating a resource datum as a function of the web page.

15. The method of claim 1, further comprising:
using at least a processor, collecting content creator data; and
using at least a processor, generating resource language as a function of the resource datum and the content creator data using a content creator data machine learning model.

16. The method of claim 1, further comprising:
using at least a processor, generating a resource locator element; and
using at least a processor, generating resource locator element as a function of the resource locator element.

17. The method of claim 1, further comprising:
using at least a processor, transmitting the resource locator element to a content creator device.

18. The method of claim 1, wherein the user input includes at least an identifier and originates from a promoted entity device.

19. The method of claim 8, further comprising:
using at least a processor, providing the at least an identifier in a historical data bin to a content creator device operated by a steaming content provider, wherein the historical data bin includes at least a smart code attached to the at least identifier;
using at least a processor, receiving, from the content creator device, a selection of the at least an identifier in the historical data bin; and
using at least a processor, generating a dual-path resource locator, wherein the dual-path resource locator identifies, using the smart code, a first path to the promoted entity device based on the selection of the at least an identifier and a second path to the content creator device based on the selection.

20. The method of claim 9, further comprising:
using at least a processor, receiving a continuous data stream from a content creator device;
using at least a processor, detecting at least a data element in the continuous data stream; and
using at least a processor, associating the dual-path resource locator with the continuous data stream as a function of the at least a data element.
